(19) United States
(12) Patent Application Publication
(10) Pub. No.: US 2023/0219495 A1
(43) Pub. Date: Jul. 13, 2023

(54) SIGNAL PROCESSING DEVICE, LIGHT ADJUSTING CONTROL METHOD, SIGNAL PROCESSING PROGRAM, AND LIGHT ADJUSTING SYSTEM

(71) Applicant: Sony Group Corporation, Tokyo (JP)

(72) Inventors: Takashi TAKAMATSU, Tokyo (JP); Hiroshi IMAMURA, Tokyo (JP); Seishi TOMONAGA, Tokyo (JP); Koji NAGATA, Tokyo (JP); Toru NAGARA, Tokyo (JP)

(73) Assignee: Sony Group Corporation, Tokyo (JP)

(21) Appl. No.: 18/000,936

(22) PCT Filed: Jun. 14, 2021
(86) PCT No.: PCT/JP2021/022440

§ 371 Date: Dec. 7, 2022

(30) Foreign Application Priority Data
Jun. 15, 2020 (JP) 2020-103385

(51) Int. Cl. B60Q 3/80; B60Q 3/70

(52) U.S. Cl. CPC B60Q 3/80; B60Q 3/735

(57) ABSTRACT

A signal processing device includes a first acquisition section that acquires first illuminance information indicating illuminance of an inside of a moving body, a second acquisition section that acquires second illuminance information indicating illuminance to be compared with the first illuminance information, and a light adjusting control section that controls a light adjustment by a device included in the moving body on a basis of a result of a comparison between illuminance of the first illuminance information and illuminance of the second illuminance information.

### FIELD

The present disclosure relates to a signal processing device, a light adjusting control method, a signal processing program, and a light adjusting system.

### BACKGROUND

With the technology development of driving assistance and of automated driving of a moving body such as an automobile, improvement of comfort in the vehicle is required. In order to improve the comfort in the vehicle, it is necessary to keep the inside of the vehicle at appropriate brightness.

### CITATION LIST

### Patent Literature

Patent Literature 1: JP 1998-159463 A
Patent Literature 2: JP 2015-518445 A

### SUMMARY

### Technical Problem

The above-described conventional technique is a technique for shielding light incident from the front of the automobile. That is, the conventional technique is a technique for reducing glare during driving, and it is difficult to improve the comfort in the vehicle.

Therefore, the present disclosure proposes a signal processing device, a light adjusting control method, a signal processing program, and a light adjusting system capable of improving the comfort in the vehicle.

### Solution to Problem

According to the present disclosure, a signal processing device includes: a first acquisition section that acquires first illuminance information indicating illuminance of an inside of a moving body; a second acquisition section that acquires second illuminance information indicating illuminance to be compared with the first illuminance information; and a light adjusting control section that controls a light adjustment by a device included in the moving body on a basis of a result of a comparison between illuminance of the first illuminance information and illuminance of the second illuminance information.

### BRIEF DESCRIPTION OF DRAWINGS

FIG. 1 is a block diagram depicting an example of a schematic hardware configuration of a light adjusting system according to a first embodiment.

FIG. 2 is a block diagram depicting an example of a functional configuration of a signal processing device according to the first embodiment.

FIG. 3 is a graph depicting an example of a light adjustment degree.

FIG. 4 is a flowchart depicting an example of a light adjustment processing executed by the light adjusting system according to the first embodiment.

FIG. 5 is a graph depicting an example of a change in illuminance radiated from the surroundings when a moving body travels on the movement route.

FIG. 6 is a block diagram depicting an example of a schematic hardware configuration of a light adjusting system according to a second embodiment.

FIG. 7 is a block diagram depicting an example of a functional configuration of the signal processing device according to the first embodiment.

FIG. 8 is a graph depicting an example of a light adjustment for explaining each mode of the light adjustment.

FIG. 9 is a graph depicting an example of the light adjustment in an environment mode.

FIG. 10 is a graph depicting an example of the light adjustment in an adaptation mode.

FIG. 11 is a graph depicting an example of the light adjustment in a fixed mode.

FIG. 12 is a flowchart depicting an example of light adjustment processing executed by a light adjusting system according to the second embodiment.

FIG. 13 is a block diagram depicting an example of a schematic hardware configuration of a light adjusting system according to a third embodiment.

FIG. 14 is a block diagram depicting an example of a functional configuration of a signal processing device according to the third embodiment.

FIG. 15 is a flowchart depicting an example of light adjustment processing executed by the light adjusting system according to the third embodiment.

FIG. 16 is a block diagram depicting an example of a schematic hardware configuration of a light adjusting system according to a fourth embodiment.

FIG. 17 is a block diagram depicting an example of a functional configuration of a signal processing device according to the fourth embodiment.

FIG. 18 is a flowchart depicting an example of light adjustment processing executed by the light adjusting system according to the fourth embodiment.

FIG. 19 is a block diagram depicting an example of a schematic hardware configuration of a light adjusting system according to a first modification of the fourth embodiment.

FIG. 20 is a block diagram depicting an example of a functional configuration of a signal processing device according to the first modification of the fourth embodiment.

FIG. 21 is a block diagram depicting an example of a schematic hardware configuration of a light adjusting system according to the first modification of the fourth embodiment.

FIG. 22 is a block diagram depicting an example of a functional configuration of a signal processing device according to the second modification of the fourth embodiment.

FIG. 23 is a block diagram depicting an example of schematic configuration of a vehicle control system.

FIG. 24 is a diagram of assistance in explaining an example of installation positions of an outside-vehicle information detecting section and an imaging section.

### DESCRIPTION OF EMBODIMENTS

Hereinafter, the embodiments of the present disclosure will be described in detail with reference to the drawings. In the following embodiments, the same parts are denoted by the same reference signs, and a duplicate description will be omitted.

Hereinafter, embodiments of the present disclosure will be described in the following order.
1. Description of problem
2. First embodiment
   2-1. Configuration of light adjusting system according to first embodiment
   2-2. Configuration of signal processing device according to first embodiment
   2-3. Light adjustment processing procedure according to first embodiment
3. Second embodiment
   3-1. Configuration of light adjusting system according to second embodiment
   3-2. Configuration of signal processing device according to second embodiment
   3-3. Light adjustment processing procedure according to second embodiment
4. Third embodiment
   4-1. Configuration of light adjusting system according to third embodiment
   4-2. Configuration of signal processing device according to third embodiment
   4-3. Light adjustment processing procedure according to third embodiment
5. Fourth embodiment
   5-1. Configuration of light adjusting system according to fourth embodiment
   5-2. Configuration of signal processing device according to fourth embodiment
   5-3. Light adjustment processing procedure according to fourth embodiment
6. First modification of fourth embodiment
   6-1. Configuration of light adjusting system according to first modification of fourth embodiment
   6-2. Configuration of signal processing device according to first modification of fourth embodiment
7. Second modification of fourth embodiment
   7-1. Configuration of light adjusting system according to second modification of fourth embodiment
   7-2. Configuration of signal processing device according to second modification of fourth embodiment
8. Application Example

### (1. Description of Problem)

With the development of technologies such as automated driving and driving assistance, the degree of importance of the comfort in the vehicle is increasing. For example, with the development of technologies such as automated driving and driving assistance, there is an increased opportunity to see a monitor or the like in the vehicle. However, the environment outside the vehicle changes variously during traveling. That is, the illuminance of the light illuminating the moving body varies. The light enters the vehicle through the window.

When light with high illuminance enters the vehicle, it is difficult to visually recognize the display device in the vehicle due to the influence of reflection or the like, or the eyes cannot follow the change in light, so that the occupant feels uncomfortable. Therefore, there is a demand for a light adjusting technology that does not make the driver feel an environmental change outside the vehicle.

### (2. First Embodiment)

### 1. Configuration of Light Adjusting System According to First Embodiment]

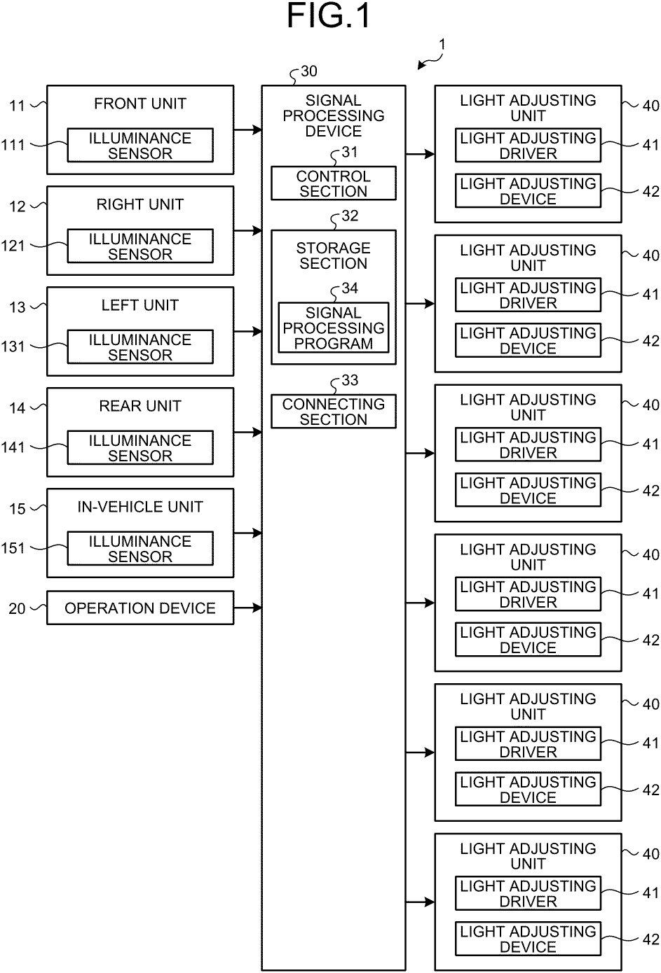

FIG. 1 is a block diagram depicting an example of a schematic hardware configuration of a light adjusting system 1 according to a first embodiment of the present disclosure. The light adjusting system 1 is mounted on a moving body. The moving body is a vehicle such as an automobile on which an occupant ride. The moving body may be a vehicle automated at any level of levels 0 to 5 defined in Society of Automotive Engineers (SAE). That is, the moving body may be a vehicle in which the moving body at level 3 autonomously controls traveling and a driver riding on the moving body can operate the moving body as necessary, may be a vehicle that is a highly automated vehicle at level 4 or higher that does not require that the driver rides on, or may be a vehicle at level 2 or lower.

The light adjusting system 1 includes a front unit 11, a right unit 12, a left unit 13, a rear unit 14, an in-vehicle unit 15, an operation device 20, a signal processing device 30, and a plurality of light adjusting units 40.

The front unit 11 is a unit that acquires information indicating an environment of the front of the moving body. More specifically, front unit 11 includes an illuminance sensor 111 at the front of the moving body. The illuminance sensor 111 is a sensor that measures illuminance of light radiated to the front of the moving body.

The right unit 12 is a unit that acquires information indicating an environment on the right side of the moving body. More specifically, the right unit 12 includes an illuminance sensor 121 on the right side of the moving body. The illuminance sensor 121 is a sensor that measures the illuminance of light radiated to the right side of the moving body.

The left unit 13 is a unit that acquires information indicating an environment on the left side of the moving body. More specifically, the left unit 13 includes an illuminance sensor 131 on the left side of the moving body. The illuminance sensor 131 is a sensor that measures the illuminance of light radiated to the left side of the moving body.

The rear unit 14 is a unit that acquires information indicating an environment of the rear of the moving body. More specifically, the rear unit 14 includes an illuminance sensor 141 at the rear of the moving body. The illuminance sensor 141 is a sensor that measures the illuminance of light radiated to the rear of the moving body.

The in-vehicle unit 15 is a unit that acquires information indicating an internal environment such as the inside of the vehicle of the moving body. More specifically, the in-vehicle unit 15 includes an illuminance sensor 151 installed in the vicinity of an indoor light or the like. That is, the in-vehicle unit 15 includes the illuminance sensor 151 installed substantially at the center of the moving body. The illuminance sensor 151 is a sensor that measures illuminance of light of the inside of the moving body.

The operation device 20 receives various operations. For example, the operation device 20 may be a touch panel display such as a car navigation, a hardware button provided on a handle or the like, or an object that receives an operation in another format.

The signal processing device 30 includes a control section 31, a storage section 32, and a connecting section 33.

The control section 31 is a controller that controls each unit of the signal processing device 30. The control section 31 is realized, for example, by a processor such as a central processing unit (CPU) or a micro processing unit (MPU). For example, the control section 31 is realized by the processor executing various programs such as a signal processing program 34 stored in a storage device such as the storage section 32 using a random access memory (RAM) or the like as a work area. The control section 31 may be realized by an integrated circuit such as an application specific integrated circuit (ASIC) or a field programmable gate array (FPGA). The CPU, the MPU, the ASIC, and the FPGA can all be considered controllers.

The storage section 32 is a data readable/writable storage device such as a dynamic random access memory (DRAM), a static random access memory (SRAM), a flash memory, and a hard disk. The storage section 32 functions as a storage means of the signal processing device 30. The storage section 32 stores, for example, the signal processing program 34. The signal processing program 34 is a program for causing a computer or the like to execute various functions of the signal processing device 30.

The connecting section 33 executes communication with each unit connected to the signal processing device 30 in a wired or wireless manner. For example, the connecting section 33 executes communication with the front unit 11, the right unit 12, the left unit 13, the rear unit 14, the in-vehicle unit 15, the operation device 20, and the plurality of light adjusting units 40.

The signal processing device 30 controls a light adjustment by a light adjusting device 42 on the basis of the illuminance measured by the illuminance sensors 111, 121, 131, 141, and 151. More specifically, the signal processing device 30 outputs a signal for controlling each of the plurality of light adjusting units 40 on the basis of signals output from the right unit 12, the left unit 13, the rear unit 14, the in-vehicle unit 15, and the operation device 20.

The light adjusting unit 40 is a unit that adjusts the brightness in the vehicle of the moving body. The light adjusting unit 40 includes a light adjusting driver 41 and the light adjusting device 42.

The light adjusting device 42 is a device that adjusts the brightness of the inside such as the inside of the moving body. For example, the light adjusting device 42 is a device that shields light incident from a window of the moving body. Specifically, the light adjusting device 42 is a liquid crystal panel that shields light incident from the window of the moving body. More specifically, the light adjusting device 42 is installed in each of the plurality of windows included in the moving body. Specifically, a windshield, a side glass on the side of the driver seat, a side glass on the side of the passenger seat, side glasses on both sides of the rear seat, a rear glass, and the like have the light adjusting device 42. As a result, the light adjusting device 42 can shield light incident from each window. Incidentally, that the light adjusting device 42 may be included in all the windows included in the moving body, or may be included in some of the windows. Furthermore, a portion other than these windows may have the light adjusting device 42. Furthermore, the light adjusting device 42 is not limited to the liquid crystal panel, but may be a light adjusting film that changes transmittance by an applied voltage, or may be a device that shields light by another method.

The light adjusting driver 41 is a driver circuit that controls a light adjustment by the light adjusting device 42 on the basis of a signal output from the signal processing device 30. The light adjusting driver 41 changes the light transmittance of the light adjusting device 42 on the basis of the signal output from the signal processing device 30. That is, the light adjusting driver 41 changes the light shielding degree indicating the degree of shielding the light transmitted through the light adjusting device 42. Furthermore, the light adjusting driver 41 can change the light shielding degree for each portion of the light adjusting device 42 on the basis of the signal output from the signal processing device 30. For example, when the light adjusting device 42 is a liquid crystal panel, the light adjusting driver 41 can change the light shielding degree in units of pixels of the liquid crystal panel.

### 2. Configuration of Signal Processing Device According to First Embodiment]

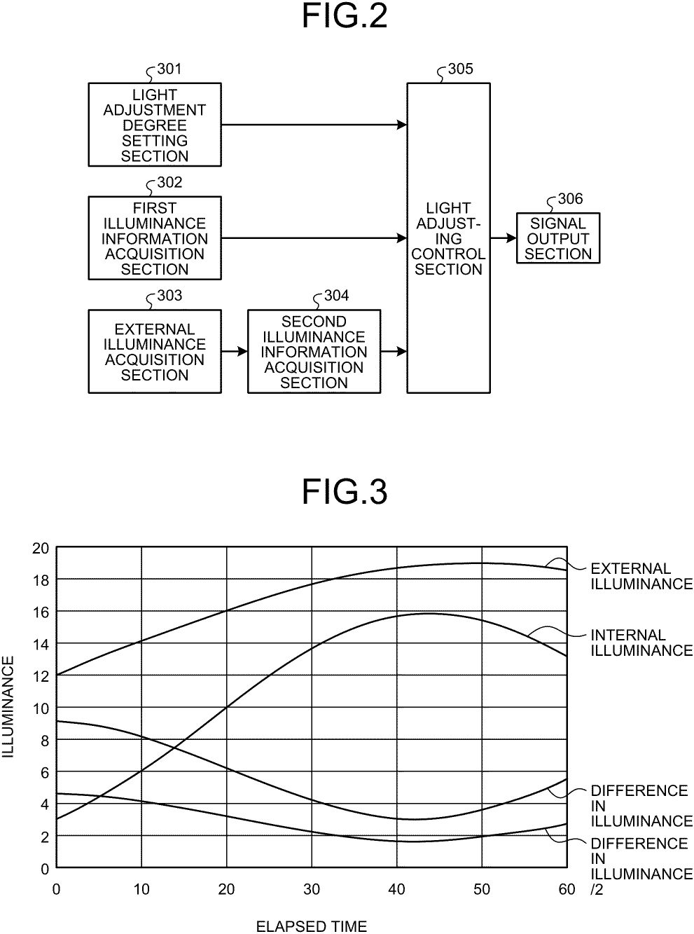

FIG. 2 is a block diagram depicting an example of a functional configuration of the signal processing device 30 according to the first embodiment of the present disclosure. The control section 31 of the signal processing device 30 includes a light adjustment degree setting section 301, a first illuminance information acquisition section 302, an external illuminance acquisition section 303, a second illuminance information acquisition section 304, a light adjusting control section 305, and a signal output section 306.

The light adjustment degree setting section 301 sets a light adjustment degree indicating a degree of a light adjustment by the light adjusting device 42. More specifically, the light adjustment degree setting section 301 sets the light adjustment degree on the basis of a signal output from the operation device 20.

FIG. 3 is a graph depicting an example of the light adjustment degree. The light adjustment degree includes a high level and a medium level. The high level is a level of the light adjustment intensity for executing light adjustment that makes the illuminance of the inside of the moving body constant regardless of the illuminance of the outside of the moving body. In the case of the high level, the signal processing device 30 performs a light adjustment so that the difference between the illuminance of the outside of the moving body and the illuminance of the inside of the moving body is eliminated. As depicted in FIG. 3, the signal processing device 30 calculates the difference between the illuminance of the outside of the moving body and the illuminance of the inside of the moving body. Then, the light adjusting device 42 shields light entering the inside of the moving body so that the illuminance of the outside of the moving body and the illuminance inside the moving body are the same.

The medium level is a level at which the light adjustment intensity is lower than the high level. In the case of the medium level, the signal processing device 30 performs a light adjustment that makes so that the difference between the external illuminance and the internal illuminance is made to be half. As depicted in FIG. 3, the signal processing device 30 calculates a value of ½ of a difference between the illuminance of the outside of the moving body and the illuminance of the inside of the moving body. Then, the light adjusting device 42 shields light entering the inside of the moving body so that the difference between the illuminance of the outside of the moving body and the illuminance inside the moving body is made to be half. The medium level light adjustment degree is not limited to ½, and may be ¼ or another value. Furthermore, the light adjustment degree is not limited to the high level and the medium level, but may be further divided into a plurality of levels.

The first illuminance information acquisition section 302 acquires first illuminance information indicating illuminance of the inside of the moving body. More specifically, the first illuminance information acquisition section 302 acquires illuminance of light of the inside of the moving body from the illuminance sensor 151 of the in-vehicle unit 15. In this manner, the first illuminance information acquisition section 302 acquires the first illuminance information indicating the illuminance of the inside of the moving body.

The external illuminance acquisition section 303 acquires the illuminance of the outside of the moving body from each of the illuminance sensors 111, 121, 131, and 141. More specifically, the external illuminance acquisition section 303 acquires the illuminance at the front of the moving body from the illuminance sensor 111 of the front unit 11. The external illuminance acquisition section 303 acquires the illuminance on the right side of the moving body from the illuminance sensor 121 of the right unit 12. The external illuminance acquisition section 303 acquires the illuminance on the left side of the moving body from the illuminance sensor 131 of the left unit 13. The external illuminance acquisition section 303 acquires the illuminance at the rear of the moving body from the illuminance sensor 141 of the rear unit 14. Then, the external illuminance acquisition section 303 outputs the acquired illuminance to the second illuminance information acquisition section 304.

The second illuminance information acquisition section 304 acquires second illuminance information indicating illuminance to be compared with the first illuminance information. That is, the second illuminance information acquisition section 304 acquires the second illuminance information indicating the illuminance measured by the illuminance sensors 111, 121, 131, and 141 that measure the illuminance of the outside of the moving body. More specifically, the second illuminance information acquisition section 304 acquires second illuminance information indicating illuminance of light at the front of the moving body measured by the illuminance sensor 111 of the front unit 11. In addition, the second illuminance information acquisition section 304 acquires the second illuminance information indicating the illuminance of the light on the right side of the moving body measured by the illuminance sensor 121 of the right unit 12. In addition, the second illuminance information acquisition section 304 acquires second illuminance information indicating the illuminance of the light on the left side of the moving body measured by the illuminance sensor 131 of the left unit 13. In addition, the second illuminance information acquisition section 304 acquires second illuminance information indicating illuminance of light at the rear of the moving body measured by the illuminance sensor 141 of the rear unit 14. In this manner, the second illuminance information acquisition section 304 acquires the second illuminance information indicating the illuminance measured by the respective illuminance sensors 111, 121, 131, and 141 associated with the plurality of light adjusting device 42 included in the moving body.

The light adjusting control section 305 controls a light adjustment by the light adjusting device 42 included in the moving body on the basis of a result of a comparison between the illuminance of the first illuminance information and the illuminance of the second illuminance information. More specifically, the light adjusting control section 305 controls a light adjustment by the light adjusting device 42 for each of the plurality of light adjusting devices 42 included in the moving body. Here, the plurality of light adjusting devices 42 included in the moving body is associated with the respective illuminance sensors 111, 121, 131, and 141. On the basis of the result of a comparison between the illuminance of the first illuminance information and the illuminance of the second illuminance information, the light adjusting control section 305 controls a light adjustment by the light adjusting devices 42 associated with the respective illuminance sensors 111, 121, 131, and 141 that have measured the illuminance of the second illuminance information. At this time, the light adjusting control section 305 controls a light adjustment by the light adjusting device 42 on the basis of the level of the light adjustment degree set by the light adjustment degree setting section 301.

Specifically, the light adjusting control section 305 compares the first illuminance information indicating the illuminance measured by the illuminance sensor 151 of the in-vehicle unit 15 with the second illuminance information indicating the illuminance measured by the illuminance sensor 111 of the front unit 11, and calculates a difference in illuminance. In addition, the light adjusting control section 305 controls a light adjustment by the light adjusting device 42 of the windshield on the basis of the difference in illuminance and the level of the light adjustment degree set by the light adjustment degree setting section 301. That is, the light adjusting control section 305 determines the light shielding degree indicating the degree of light shielding by the light adjusting device 42.

Furthermore, the light adjusting control section 305 compares the first illuminance information indicating the illuminance measured by the illuminance sensor 151 of the in-vehicle unit 15 with the second illuminance information indicating the illuminance measured by the illuminance sensor 121 of the right unit 12, and calculates a difference in illuminance. In addition, the light adjusting control section 305 controls a light adjustment by the light adjusting device 42 of the side glass on the right side of the moving body on the basis of the difference in illuminance and the level of the light adjustment degree set by the light adjustment degree setting section 301. That is, the light adjusting control section 305 determines the light shielding degree indicating the degree of light shielding by the light adjusting device 42 included in the side glass on the side of the driver seat or the side glass on the side of the rear seat.

Furthermore, the light adjusting control section 305 compares the first illuminance information indicating the illuminance measured by the illuminance sensor 151 of the in-vehicle unit 15 with the second illuminance information indicating the illuminance measured by the illuminance sensor 131 of the left unit 13, and calculates a difference in illuminance. In addition, the light adjusting control section 305 controls a light adjustment by the light adjusting device 42 of the side glass on the left side of the moving body on the basis of the difference in illuminance and the level of the light adjustment degree set by the light adjustment degree setting section 301. That is, the light adjusting control section 305 determines the light shielding degree indicating the degree of light shielding by the light adjusting device 42 included in the side glass on the side of the driver seat or the side glass on the side of the rear seat.

Furthermore, the light adjusting control section 305 compares the first illuminance information indicating the illuminance measured by the illuminance sensor 151 of the in-vehicle unit 15 with the second illuminance information indicating the illuminance measured by the illuminance sensor 141 of the rear unit 14, and calculates a difference in illuminance. In addition, the light adjusting control section 305 controls a light adjustment by the light adjusting device 42 of the rear glass at the rear of the moving body on the basis of the difference in illuminance and the level of the light adjustment degree set by the light adjustment degree setting section 301. That is, the light adjusting control section 305 determines the light shielding degree indicating the degree of light shielding by the light adjusting device 42 included in the rear glass.

In this manner, the light adjusting control section 305 determines the light shielding degree of the light adjusting device 42 on the basis of the difference between the illuminance in the vehicle and the illuminance outside the vehicle. That is, the light adjusting control section 305 determines the light shielding degree of the light incident from the outside of the vehicle so as to maintain uniform brightness in the vehicle. Therefore, since the light adjusting control section 305 prevents the brightness in the vehicle from being rapidly changed, it is possible to improve the comfort in the vehicle.

Furthermore, the light adjusting control section 305 controls a light adjustment by the light adjusting device 42 for each portion of the light adjusting device 42. More specifically, in a case where the light adjusting device 42 is a liquid crystal panel that shields light entering the inside of the moving body, a portion to be shielded is controlled in units of pixels. Furthermore, the light adjusting control section 305 can change the light shielding degree in a gradation manner for the light shielding portion of the light adjusting device 42. Thus, the light adjusting control section 305 can shield light according to the position of light incident from the window.

The signal output section 306 outputs a signal indicating the light shielding degree determined by the light adjusting control section 305 to each of the light adjusting units 40. The light adjusting driver 41 of the light adjusting unit 40 controls the light adjusting device 42 on the basis of the signal output from the signal output section 306.

### 3. Light Adjustment Processing Procedure According to First Embodiment]

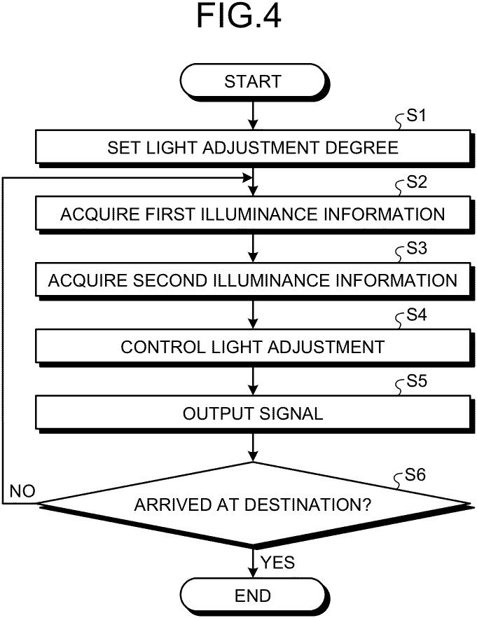

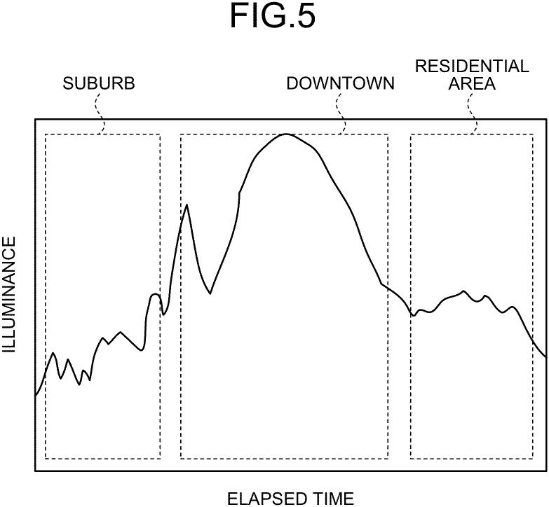

FIG. 4 is a flowchart depicting an example of the light adjustment processing executed by the light adjusting system 1 according to the first embodiment of the present disclosure.

The light adjustment degree setting section 301 sets a light adjustment degree indicating a degree of a light adjustment by the light adjusting device 42 (step S1). That is, the light adjustment degree setting section 301 sets the level of the light adjustment degree on the basis of the operation received by the operation device 20.

The first illuminance information acquisition section 302 acquires first illuminance information indicating illuminance of the inside of the moving body (step S2). The second illuminance information acquisition section 304 acquires second illuminance information indicating illuminance of the outside of the moving body (step S3).

The light adjusting control section 305 controls a light adjustment by the light adjusting device 42 included in the moving body on the basis of the first illuminance information and the second illuminance information (step S4). That is, the light adjusting control section 305 determines the light shielding degree indicating the degree of light shielding by the light adjusting device 42.

The signal output section 306 outputs a signal indicating the light shielding degree determined by the light adjusting control section 305 to each of the light adjusting units 40 (step S5). Then, the light adjusting driver 41 causes the light adjusting device 42 to shield light on the basis of the signal output from the signal output section 306.

The signal processing device 30 determines whether the moving body has arrived at the destination (step S6). In a case where the moving object has not arrived at the destination (step S6; No), the signal processing device 30 proceeds to step S2 and continues the process.

In a case where the moving object has arrived at the destination (step S6; Yes), the signal processing device 30 ends the light adjustment processing.

As described above, the signal processing device 30 according to the first embodiment determines the light shielding degree of the light adjusting device 42 on the basis of the result of a comparison between the illuminance of the inside of the moving body acquired by the first illuminance information acquisition section 302 and the illuminance of the outside of the moving body acquired by the second illuminance information acquisition section 304. That is, the signal processing device 30 adjusts light incident from the outside of the vehicle so as to maintain uniform brightness in the vehicle. Therefore, since the signal processing device 30 prevents the brightness in the vehicle from being suddenly changed, it is possible to improve the comfort in the vehicle.

### (3. Second Embodiment)

The light adjusting system 1a according to the second embodiment predicts future illuminance on the basis of a car navigation system. The same components as those of the first embodiment are denoted by the same reference numerals, and the description thereof will be omitted.

When a destination is set, the car navigation system determines a movement route to the destination. A light adjusting system 1a predicts illuminance of light radiated from the surroundings when the moving body travels on the movement route on the basis of the movement route determined by the car navigation system and the map information.

Here, FIG. 5 is a graph depicting an example of a change in illuminance of light radiated from the surroundings when the moving body travels on the movement route. The vertical axis represents illuminance. The horizontal axis indicates the elapsed time from the start. That is, the horizontal axis depicted in FIG. 5 indicates the illuminance at the point where the moving body reaches when the moving body travels for the elapsed time. The moving body depicted in FIG. 5 passes through the suburb, the downtown, and the residential area and arrives at the destination. The moving body is irradiated with light of relatively low illuminance in the suburb. The moving body is irradiated with light of relatively high illuminance in a downtown. Then, the moving body is irradiated with light of low illuminance in a residential area.

In this way, by determining the movement route of the moving body, the illuminance of the light with which the moving body is irradiated can be predicted. Therefore, the light adjusting system 1a sets a target value of the light adjustment at each point in advance on the basis of the predicted illuminance. Then, the light adjusting system 1a can suppress a rapid change in light adjustment by adjusting light on the basis of the target value.

### 1. Configuration of Light Adjusting System According to Second Embodiment]

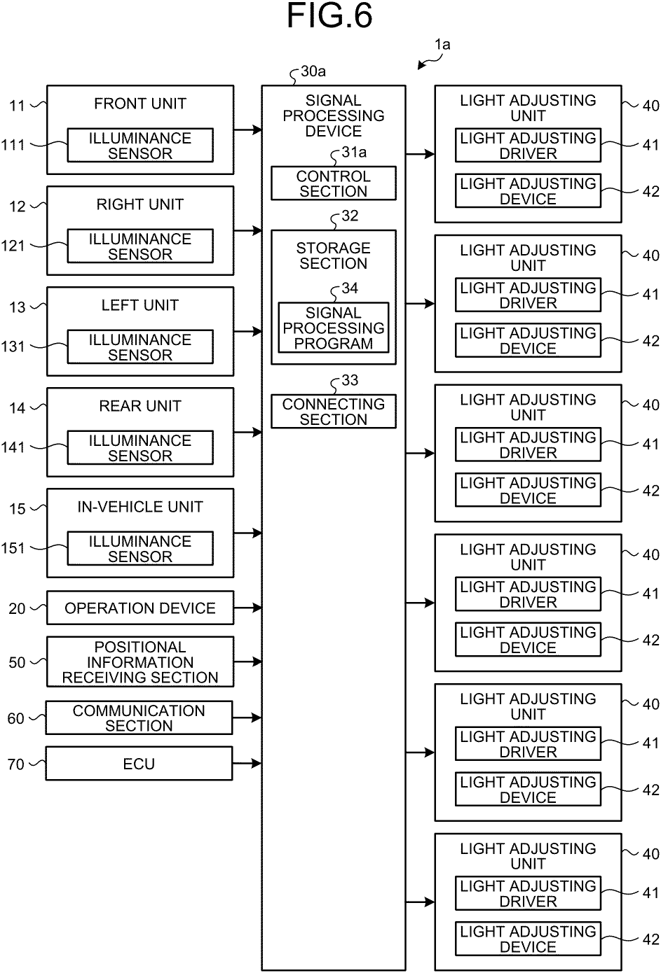

FIG. 6 is a block diagram depicting an example of a schematic hardware configuration of the light adjusting system 1a according to a second embodiment of the present disclosure. As in the light adjusting system 1a according to the first embodiment, the light adjusting system 1a includes the front unit 11, the right unit 12, the left unit 13, the rear unit 14, the in-vehicle unit 15, the operation device 20, a signal processing device 30a, and a plurality of light adjusting units 40. Furthermore, the light adjusting system 1a includes a positional information receiving section 50, a communication section 60, and an engine control unit (ECU) 70.

The positional information receiving section 50 receives positional information indicating a current position of the moving body from a system that measures the current position of the moving body, such as a global navigation satellite system (GNSS).

The communication section 60 receives map information.

The map information is a map used in a car navigation system. In the map information, information indicating illuminance of light radiated to a traveling area of the moving body such as a road or a parking lot is registered for each point. For example, information indicating illuminance of light radiated from a structure such as a building, a signboard, a street lamp, or a tunnel on a map, and illuminance of light finally radiated when the structure blocks light is registered in the map information. As a result, the signal processing device 30a can predict the illuminance of light with which the moving body is irradiated when the moving body travels on the movement route set by the car navigation system.

The ECU 70 controls traveling and the like of the moving body. Further, the ECU 70 acquires the traveling speed of the moving body. In addition, the ECU 70 may acquire other information such as the traveling direction of the moving body in addition to the traveling speed.

### 2. Configuration of Signal Processing Device According to Second Embodiment]

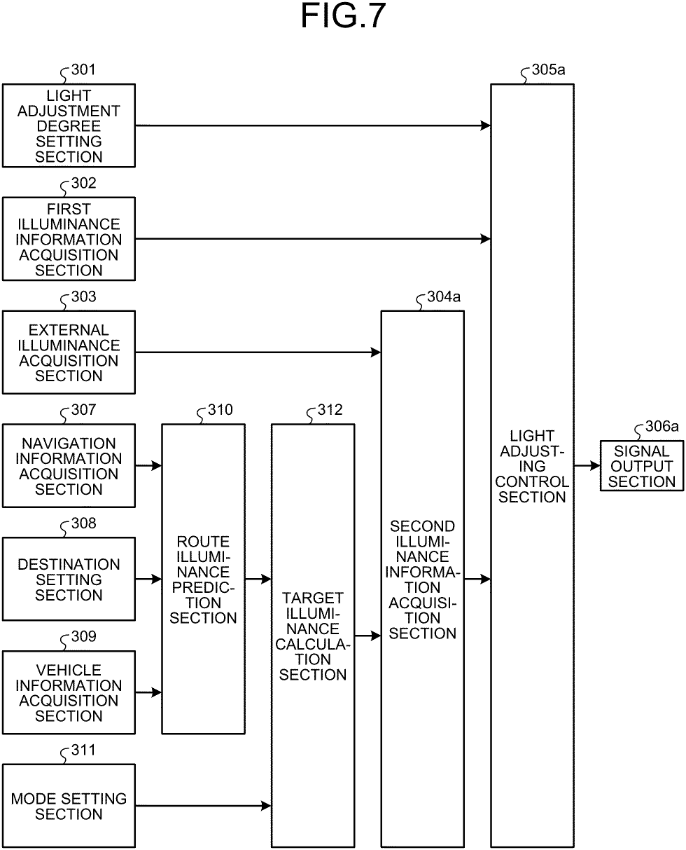

FIG. 7 is a block diagram depicting an example of a functional configuration of the signal processing device 30a according to the first embodiment of the present disclosure. A control section 31a of the signal processing device 30a includes the light adjustment degree setting section 301, the first illuminance information acquisition section 302, the external illuminance acquisition section 303, a navigation information acquisition section 307, a destination setting section 308, a vehicle information acquisition section 309, a route illuminance prediction section 310, a mode setting section 311, a target illuminance calculation section 312, a second illuminance information acquisition section 304a, a light adjusting control section 305a, and a signal output section 306a.

The light adjustment degree setting section 301, the first illuminance information acquisition section 302, and the external illuminance acquisition section 303 have functions similar to those of the first embodiment.

The navigation information acquisition section 307 acquires information of a car navigation system. More specifically, the navigation information acquisition section 307 controls the positional information receiving section 50 to acquire positional information having coordinates or the like indicating the current position of the moving body. Further, the navigation information acquisition section 307 controls the communication section 60 to acquire map information which is a map of an area where the moving body travels.

The vehicle information acquisition section 309 controls the ECU 70 to acquire vehicle information including speed information indicating the moving speed of the moving body, traveling direction information indicating the traveling direction of the moving body, and the like.

The destination setting section 308 sets a destination of the moving body. More specifically, the destination setting section 308 sets the destination of the moving body on the basis of the input received by the operation device 20 or the like.

The route illuminance prediction section 310 predicts predicted illuminance indicating a prediction value of illuminance of the outside of the moving body. Here, in the map information, information indicating illuminance of light with which a traveling area of a moving body such as a road or a parking lot is irradiated is registered for each point. Therefore, the route illuminance prediction section 310 predicts the predicted illuminance on the basis of the map information indicating the illuminance of surroundings of the movement route of the moving body to the destination.

More specifically, the route illuminance prediction section 310 calculates a movement route from the current position to the destination on the basis of the positional information, the map information, and the destination. Then, the route illuminance prediction section 310 calculates the predicted illuminance at each point of the movement route on the basis of the map information, the movement route, and the speed information indicating the moving speed of the moving body. In other words, the route illuminance prediction section 310 calculates the predicted illuminance at each elapsed time from the start of traveling of the moving body. When the navigation information acquisition section 307 acquires a movement route from the current location to the destination, the route illuminance prediction section 310 may acquire the movement route. Then, the route illuminance prediction section 310 may calculate the predicted illuminance using the acquired movement route.

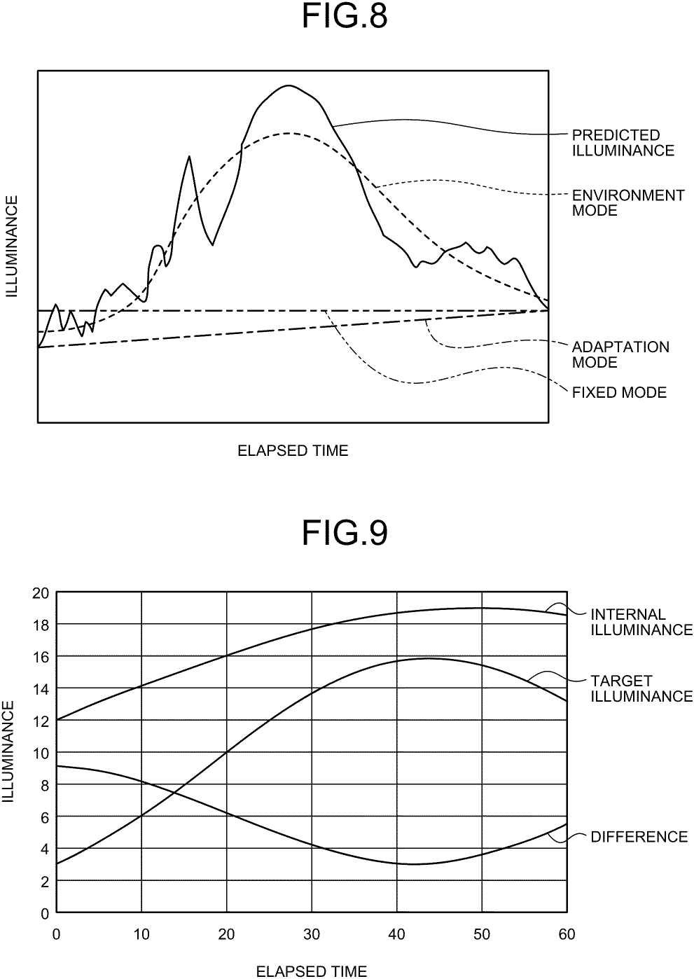

The mode setting section 311 sets a light adjustment mode. The light adjustment mode includes an environment mode, an adaptation mode, a fixed mode, and the like. FIG. 8 is a graph depicting an example of the light adjustment for explaining each mode of the light adjustment. In the graph depicted in FIG. 8, the vertical axis represents the illuminance. In addition, the horizontal axis indicates the elapsed time from the start of the moving body. That is, the horizontal axis indicates the illuminance at the point of the moving body at the elapsed time. In addition, the graph depicted in FIG. 8 indicates the predicted illuminance at each point predicted by the route illuminance prediction section 310 and the target illuminance indicating the target value of the illuminance of the inside of the moving body at each point in a case where the light is adjusted in each mode.

The environment mode is a mode in which light is adjusted to have illuminance, according to the surrounding environment, indicated by the predicted illuminance. Here, the occupant may feel uncomfortable when the light adjustment degree is suddenly changed according to the predicted illuminance. Therefore, as depicted in FIG. 8, in the environment mode, the target illuminance gently changes according to the predicted illuminance at each point.

The adaptation mode is a mode in which light is adjusted to be adapted to the predicted illuminance at the destination in a stepwise manner. Therefore, as depicted in FIG. 8, in the adaptation mode, the target illuminance linearly changes from the current location of the moving body to the destination.

The fixed mode is a mode in which light is adjusted such that the illuminance of the inside of the moving body is fixed to a constant value. Therefore, as depicted in FIG. 8, in the fixed mode, the target illuminance is constant. Then, the mode setting section 311 sets a mode to the environment mode, the adaptation mode, or the fixed mode on the basis of the input received by the operation device 20 or the like.

The target illuminance calculation section 312 calculates a target illuminance indicating a target value of illuminance of the inside of the moving body on the basis of the predicted illuminance. More specifically, the target illuminance calculation section 312 calculates the target illuminance on the basis of the light adjustment mode and the predicted illuminance.

In the case of the environment mode, the target illuminance calculation section 312 calculates the target illuminance by a statistical method on the basis of the predicted illuminance at each point of the movement route of the moving body. For example, the target illuminance calculation section 312 calculates a median value or an average value of predicted illuminance values at surroundings including neighboring points on the movement route at a certain point. Then, the target illuminance calculation section 312 sets the calculated median value or average value as the target illuminance. Alternatively, the target illuminance calculation section 312 calculates a line on which the error between the predicted illuminance valuess is reduced by the least squares method with respect to the predicted illuminance at each point on the movement route of the moving body. Then, the target illuminance calculation section 312 may set the value indicated by the calculated line as the target illuminance at the elapsed time, that is, at the point. The method is merely an example, and the target illuminance may be calculated by other methods.

In the case of the adaptation mode, the target illuminance calculation section 312 calculates a target illuminance that linearly changes from the predicted illuminance at the current location of the moving body to the predicted illuminance at the destination. Then, the target illuminance calculation section 312 sets the value indicated by the calculated line as the target illuminance at the elapsed time, that is, at the point.

In the fixed mode, the target illuminance calculation section 312 sets the designated fixed value as the target illuminance. The fixed value may be a preset value or a value designated when the fixed mode is selected.

The second illuminance information acquisition section 304a acquires the illuminance of the outside of the moving body acquired by the external illuminance acquisition section 303 and the target illuminance calculated by the target illuminance calculation section 312. Then, the second illuminance information acquisition section 304a outputs, to the light adjusting control section 305a, the second illuminance information including the illuminance of the outside of the moving body acquired by the second illuminance information acquisition section 304a and the target illuminance calculated by the target illuminance calculation section 312.

The light adjusting control section 305a controls a light adjustment by the light adjusting device 42 included in the moving body on the basis of a result of a comparison between the illuminance of the first illuminance information and the target illuminance of the second illuminance information.

Here, FIG. 9 is a graph depicting an example of the light adjustment in the environment mode. As depicted in FIG. 9, the light adjusting control section 305a calculates a difference between the illuminance of the inside of the moving body and the target illuminance at each elapsed time from the start of the movement. That is, the light adjusting control section 305a calculates a difference between the illuminance of the inside of the moving body indicated by the first illuminance information and the target illuminance indicated by the second illuminance information at each point of the movement route.

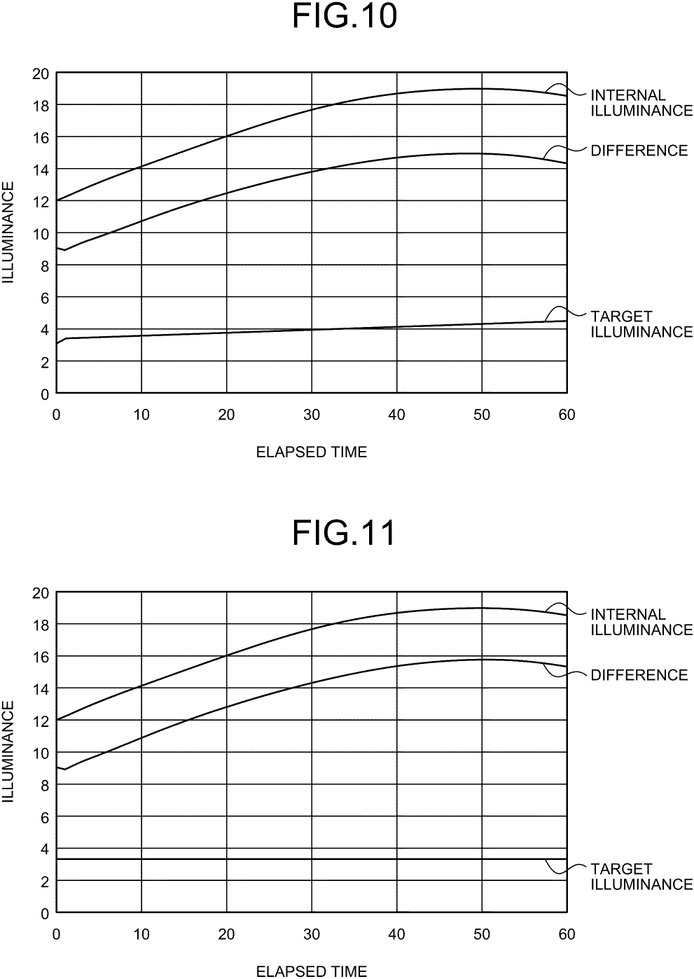

Here, FIG. 10 is a graph depicting an example of the light adjustment in the adaptation mode. As depicted in FIG. 10, the light adjusting control section 305a calculates a difference between the illuminance of the inside of the moving body and the target illuminance at each elapsed time from the start of the movement. That is, the light adjusting control section 305a calculates a difference between the illuminance of the inside of the moving body indicated by the first illuminance information and the target illuminance indicated by the second illuminance information at each point of the movement route.

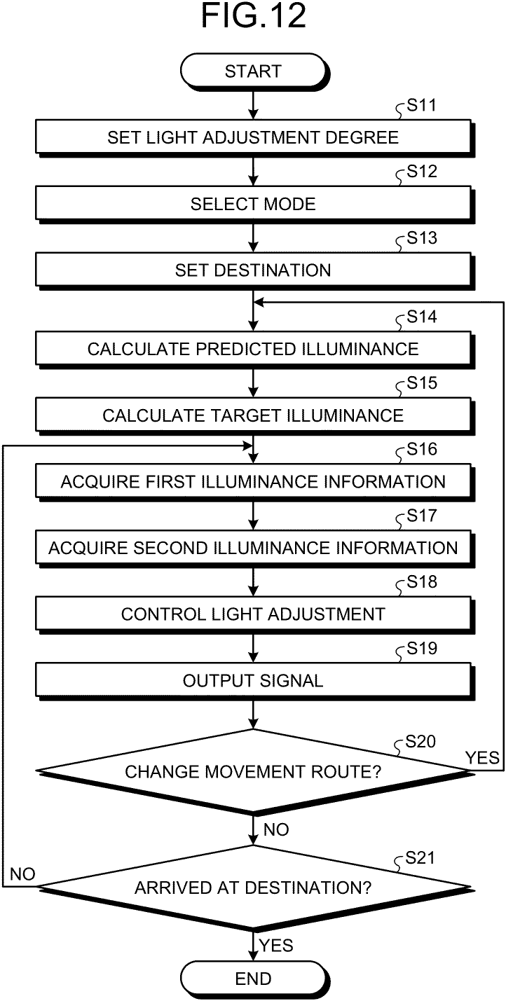

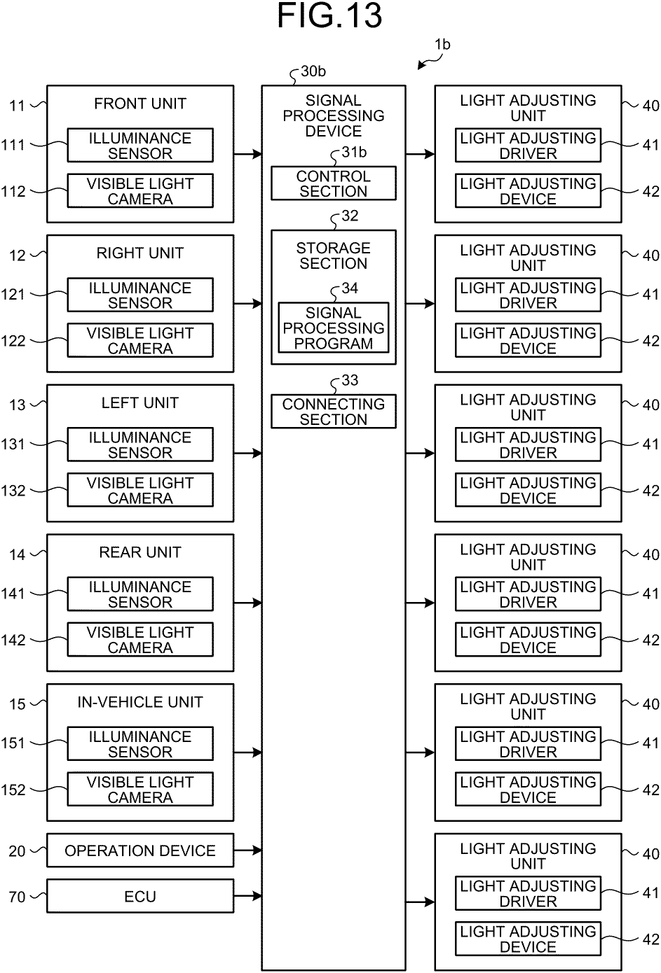

Here, FIG. 11 is a graph depicting an example of the light adjustment in a fixed mode. As depicted in FIG. 11, the light adjusting control section 305a calculates a difference between the illuminance of the inside of the moving body and the target illuminance at each elapsed time from the start of the movement. That is, the light adjusting control section 305a calculates a difference between the illuminance of the inside of the moving body indicated by the first illuminance information and the target illuminance indicated by the second illuminance information at each point of the movement route.

The light adjusting control section 305a sets the calculated difference as the light shielding degree by the light adjusting device 42. That is, the light adjusting control section 305a shields the incident light by an amount indicated by the calculated difference. As a result, the light adjusting control section 305a adapts the illuminance of the incident light to the target illuminance.

Furthermore, as in the first embodiment, the light adjusting control section 305a may control a light adjustment by the light adjusting device 42 on the basis of a difference between the internal illuminance included in the first acquisition information and the external illuminance included in the second acquisition information. Furthermore, as in the first embodiment, the light adjusting control section 305a may control a light adjustment by the light adjusting device 42 on the basis of the difference in illuminance and the level of the light adjustment degree set by the light adjustment degree setting section 301. As a result, even when there is an error in the predicted illuminance, the light adjustment degree setting section 301 can control a light adjustment to be suitable for the actual illuminance. Furthermore, the light adjusting control section 305a according to the second embodiment controls a light adjustment before arrival at the current point so that the illuminance is suitable for the current point according to the target illuminance. Therefore, the light adjusting control section 305a can suppress a rapid change in light adjustment.

The signal output section 306a outputs a signal indicating the light shielding degree determined by the light adjusting control section 305a to each of the light adjusting units 40.

### 3. Light Adjustment Processing Procedure According to Second Embodiment]

FIG. 12 is a flowchart depicting an example of the light adjustment processing executed by the light adjusting system 1a according to the second embodiment of the present disclosure.

The light adjustment degree setting section 301 sets a light adjustment degree indicating a degree of a light adjustment by the light adjusting device 42 (step S11). That is, the light adjustment degree setting section 301 sets the level of light adjustment on the basis of the operation received by the operation device 20.

The mode setting section 311 sets a light adjustment mode (step S12). That is, the mode setting section 311 sets one of the environment mode, the adaptation mode, and the fixed mode.

The destination setting section 308 sets a destination of the moving body (step S13).

The route illuminance prediction section 310 calculates the predicted illuminance at each elapsed time, that is, at each point of the movement route, on the basis of the information acquired by the navigation information acquisition section 307 and the destination (step S14).

The target illuminance calculation section 312 calculates the target illuminance at each point on the movement route on the basis of the predicted illuminance and the light adjustment mode (step S15).

The first illuminance information acquisition section 302 acquires first illuminance information indicating illuminance of the inside of the moving body (step S16). The second illuminance information acquisition section 304a acquires the second illuminance information indicating the illuminance of the outside of the moving body and the target illuminance at each point of the movement route (step S17).

The light adjusting control section 305a controls a light adjustment by the light adjusting device 42 included in the moving body on the basis of the first illuminance information and the second illuminance information (step S18). That is, the light adjusting control section 305a determines the light shielding degree indicating the degree of light shielding by the light adjusting device 42.

The signal output section 306a outputs a signal indicating the light shielding degree determined by the light adjusting control section 305a to each of the light adjusting units 40 (step S19). Then, the light adjusting driver 41 causes the light adjusting device 42 to shield light on the basis of the signal output from the signal output section 306a.

The navigation information acquisition section 307 determines whether the movement route has been changed (step S20). That is, the navigation information acquisition section 307 determines whether positional information indicating a position deviated from the set movement route has been acquired. In a case where the movement route is changed (step S20; Yes), the light adjusting system 1a proceeds to step S16.

In a case where the movement route has not been changed (step S20; No), the navigation information acquisition section 307 determines whether the moving object has arrived at the destination (step S21). That is, the navigation information acquisition section 307 determines whether positional information indicating a destination has been acquired. In a case where the moving object has not arrived at the destination (step S21; No), the first illuminance information acquisition section 302 acquires the first illuminance information in step S14.

In a case where the moving object has arrived at the destination (step S21; Yes), the light adjusting system 1a ends the light adjustment processing.

As described above, the signal processing device 30a according to the second embodiment predicts the predicted illuminance with which the moving body is irradiated in the future on the basis of the information of the car navigation system. Furthermore, the signal processing device 30a calculates a target illuminance in the vehicle of the moving body at each point on the basis of the predicted illuminance. Then, the signal processing device 30a determines the light shielding degree of the light adjusting device 42 on the basis of a difference between the illuminance in the vehicle of the moving body and the target illuminance. That is, the signal processing device 30a adjusts light incident from the outside of the vehicle such that the illuminance in the vehicle is the target illuminance. Therefore, since the brightness in the vehicle is the target illuminance calculated in advance, the signal processing device 30a can improve the comfort in the vehicle. Furthermore, the signal processing device 30a can suppress sudden light shielding by shielding light so as to conform to the target illuminance calculated in advance.

### (4. Third Embodiment)

The light adjusting system 1b according to the third embodiment predicts future illuminance on the basis of captured image information. The same components as those of the first embodiment are denoted by the same reference numerals, and the description thereof will be omitted.

A light adjusting system 1b acquires a state of light of surroundings from image information obtained by imaging the surroundings of the moving body. For example, it is assumed that a light source such as a street lamp is shown in the image information. The light adjusting system 1b calculates the time at which the moving body is irradiated with the light of the light source on the basis of the distance to the street lamp and the moving speed of the moving body. Furthermore, the light adjusting system 1b estimates the illuminance of the light radiated from the light source on the basis of the image information, the measurement values of the illuminance sensors 111, 121, 131, 141, and 151, and the like. In this way, the light adjusting system 1b predicts future illuminance on the basis of the image information.

### 1. Configuration of Light Adjusting System According to Third Embodiment]

FIG. 13 is a block diagram depicting an example of a schematic hardware configuration of the light adjusting system 1b according to a third embodiment of the present disclosure. As in the light adjusting system 1b according to the first embodiment, the light adjusting system 1b includes the front unit 11, the right unit 12, the left unit 13, the rear unit 14, the in-vehicle unit 15, the operation device 20, a signal processing device 30b, and a plurality of light adjusting units 40. Further, the front unit 11, the right unit 12, the left unit 13, the left unit 13, and the in-vehicle unit 15 of the light adjusting system 1b include visible light cameras 112, 122, 132, 142, and 152, respectively. For example, the visible light camera 152 of the in-vehicle unit 15 is attached to a room mirror. Then, the visible light camera 152 is directed forward of the moving body.

The visible light cameras 112, 122, 132, 142, and 152 are cameras that capture visible light. For example, the visible light cameras 112, 122, 132, 142, and 152 generate image information in a red green blue (RGB) format by imaging an imaging region.

The light adjusting system 1b includes an ECU 70. The ECU 70 controls traveling and the like of the moving body. The ECU 70 acquires the traveling speed of the moving body.

### 2. Configuration of Signal Processing Device According to Third Embodiment]

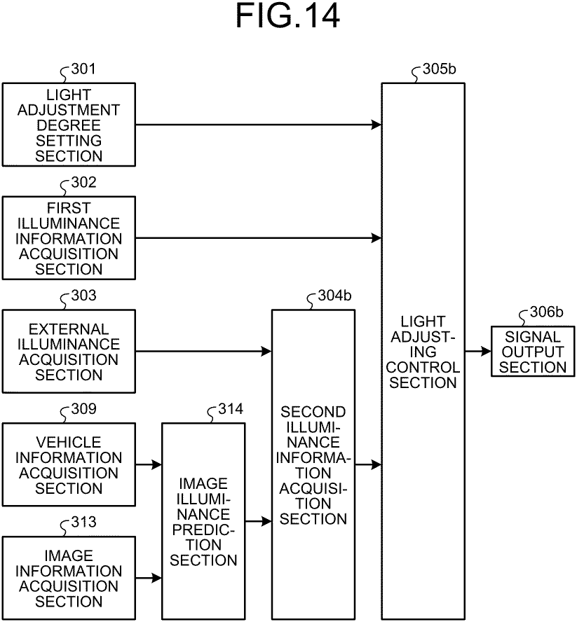

FIG. 14 is a block diagram depicting an example of a functional configuration of the signal processing device 30b according to the third embodiment of the present disclosure. The control section 31b of the signal processing device 30b includes the light adjustment degree setting section 301, the first illuminance information acquisition section 302, the external illuminance acquisition section 303, the vehicle information acquisition section 309, an image information acquisition section 313, an image illuminance prediction section 314, a second illuminance information acquisition section 304b, a light adjusting control section 305b, and a signal output section 306b.

The light adjustment degree setting section 301, the first illuminance information acquisition section 302, and the external illuminance acquisition section 303 have functions similar to those of the first embodiment.

The image information acquisition section 313 controls the visible light cameras 112, 122, 132, 142, and 152 to acquire image information about surroundings of the moving body from the respective visible light cameras 112, 122, 132, 142, and 152. Then, the image information acquisition section 313 outputs the image information to the image illuminance prediction section 314.

In addition, the vehicle information acquisition section 309 controls the ECU 70 to acquire vehicle information including speed information indicating the moving speed of the moving body, traveling direction information indicating the traveling direction of the moving body, and the like.

The image illuminance prediction section 314 predicts predicted illuminance indicating a prediction value of illuminance of the outside of the moving body on the basis of the image information about surroundings of the moving body acquired by the image information acquisition section 313.

More specifically, the image illuminance prediction section 314 detects a light source or a shadow from the image information. The image illuminance prediction section 314 calculates the distance from the moving body to the light source or the shadow. For example, the image illuminance prediction section 314 measures a distance to a light source or a shadow using images captured at different points. Incidentally, a method of measuring the distance to the light source or the shadow is an example, and the distance may be measured by another method.

Furthermore, the image illuminance prediction section 314 calculates the time to reach an object to be detected such as the light source, the shadow, or the like on the basis of the distance to the light source or the shadow, the moving speed of the moving body indicated by the vehicle information, and the traveling direction of the moving body. Furthermore, the image illuminance prediction section 314 acquires predicted illuminance indicating a prediction value of illuminance of a light source or a shadow on the basis of the image information. In this way, the image illuminance prediction section 314 predicts that the illuminance of the outside of the moving body is the predicted illuminance when the arrival time has elapsed.

The image illuminance prediction section 314 may detect not only a light source or a shadow but also a structure that emits light, such as a street lamp, a building, or a signboard, or a structure that blocks radiation of light, such as a tunnel, from the image information. In this case, the image illuminance prediction section 314 calculates the time to reach the detected structure. In addition, the image illuminance prediction section 314 acquires predicted illuminance indicating a prediction value of illuminance of light radiated or blocked by the structure on the basis of the image information. Then, the image illuminance prediction section 314 may predict that the illuminance of the outside of the moving body is the predicted illuminance when the arrival time has elapsed.

Furthermore, the road surface on which the moving body travels has different reflectance depending on the type. For example, an asphalt-paved road surface has a lower light reflectance than a concrete paved road surface. Therefore, the image illuminance prediction section 314 may detect the type of the road surface on which the moving body travels. Further, the image illuminance prediction section 314 calculates the time to reach the detected road surface. In addition, the image illuminance prediction section 314 acquires predicted illuminance indicating a prediction value of illuminance of light reflected by the road surface on the basis of the image information. Then, the image illuminance prediction section 314 may predict that the illuminance of the outside of the moving body is the predicted illuminance when the arrival time has elapsed.

The second illuminance information acquisition section 304b acquires the illuminance of the outside of the moving body acquired by the external illuminance acquisition section 303 and the predicted illuminance predicted by the image illuminance prediction section 314. Then, the second illuminance information acquisition section 304b outputs, to the light adjusting control section 305b, the second illuminance information including the illuminance of the outside of the moving body acquired by the second illuminance information acquisition section 304b and the predicted illuminance predicted by the image illuminance prediction section 314.

The light adjusting control section 305b controls a light adjustment by the light adjusting device 42 included in the moving body on the basis of a result of a comparison between the illuminance of the first illuminance information and the predicted illuminance of the second illuminance information. More specifically, the light adjusting control section 305b compares the current illuminance of the inside of the moving body indicated by the first illuminance information with the predicted illuminance indicated by the second illuminance information, and changes the light shielding degree in a stepwise manner. For example, when the predicted illuminance at the time when the time to reach the object to be detected of the image illuminance prediction section 314 has elapsed is higher than the current illuminance, the light adjusting control section 305b increases the light shielding degree in a stepwise manner. On the other hand, when the predicted illuminance at the time when the time to reach the object to be detected of the image illuminance prediction section 314 has elapsed is lower than the current illuminance, the light adjusting control section 305b decreases the light shielding degree in a stepwise manner. As a result, the light adjusting control section 305b prevents the illuminance of the inside of the moving body from rapidly changing and prevents the light shielding degree of the light adjusting device 42 from rapidly increasing. That is, the light adjusting control section 305b can reduce the occupant’s discomfort caused by a sudden change in illuminance and light shielding degree.

Furthermore, as in the first embodiment, the light adjusting control section 305b may control a light adjustment by the light adjusting device 42 on the basis of a difference between the internal illuminance included in the first acquisition information and the external illuminance included in the second acquisition information. Furthermore, as in the first embodiment, the light adjusting control section 305b may control a light adjustment by the light adjusting device 42 on the basis of the difference in illuminance and the level of the light adjustment degree set by the light adjustment degree setting section 301. As a result, even when there is an error in the predicted illuminance, the light adjustment degree setting section 301 can control a light adjustment to be suitable for the actual illuminance. Furthermore, the light adjusting control section 305b according to the third embodiment controls a light adjustment before arrival at the current point so that the illuminance is suitable for the current point by the predicted illuminance. Therefore, the light adjusting control section 305b can suppress a rapid change in light adjustment.

The signal output section 306b outputs a signal indicating the light shielding degree determined by the light adjusting control section 305b to each of the light adjusting units 40.

### 3. Light Adjustment Processing Procedure According to Third Embodiment]

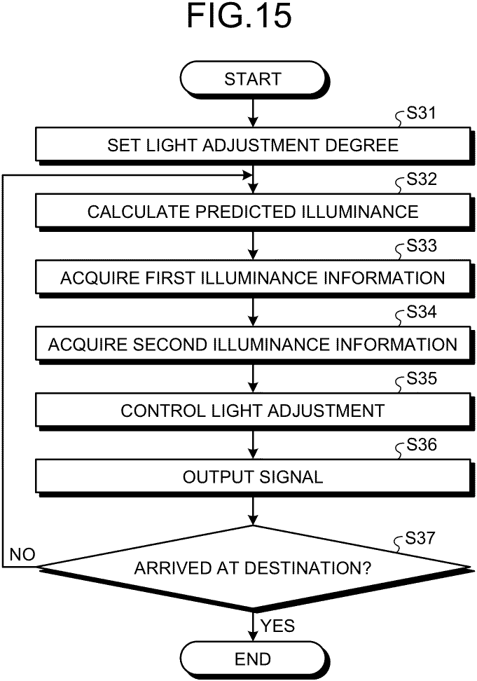

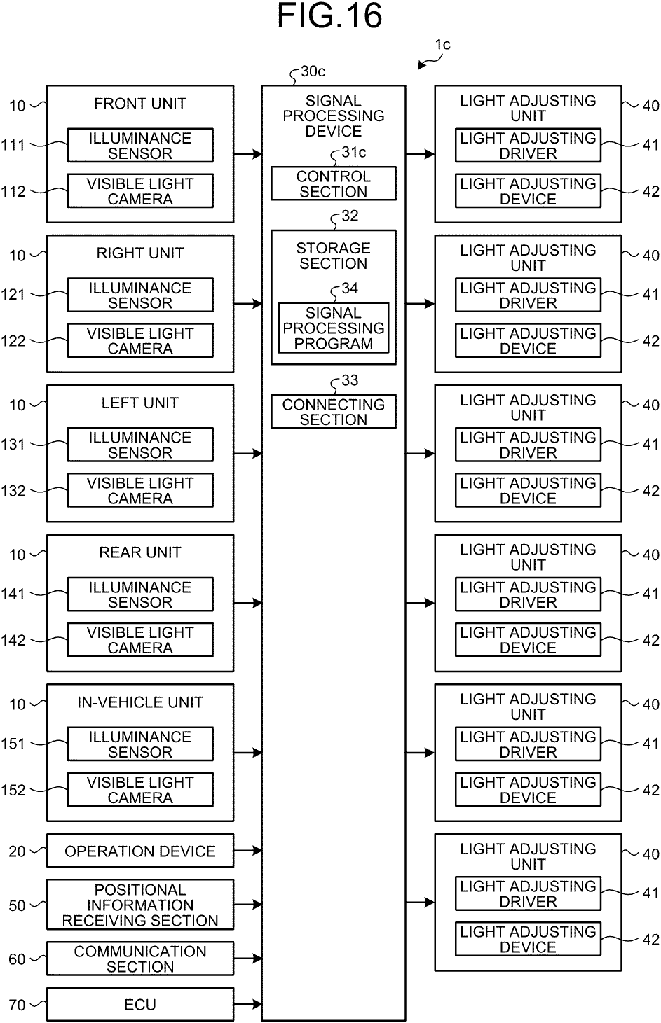

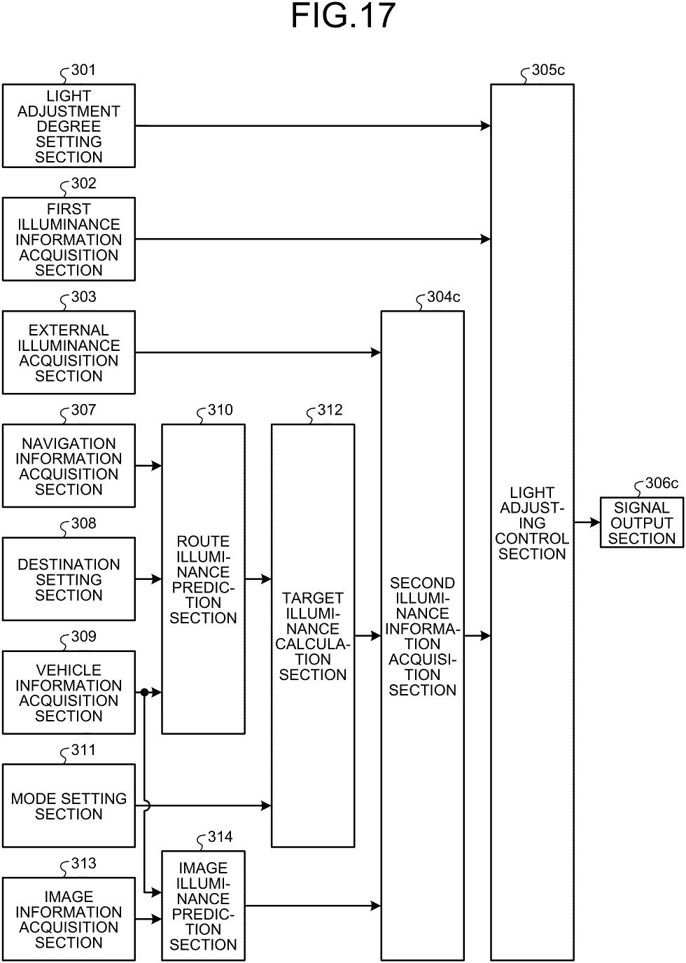

FIG. 15 is a flowchart depicting an example of the light adjustment processing executed by the light adjusting system 1b according to the third embodiment of the present disclosure.

The light adjustment degree setting section 301 sets a light adjustment degree indicating a degree of a light adjustment by the light adjusting device 42 (step S31). That is, the light adjustment degree setting section 301 sets the level of light adjustment on the basis of the operation received by the operation device 20.

The image illuminance prediction section 314 calculates predicted illuminance indicating a prediction value of illuminance of the outside of the moving body on the basis of the image information acquired by the image information acquisition section 313 (step S32).

The first illuminance information acquisition section 302 acquires first illuminance information indicating illuminance of the inside of the moving body (step S33).

The second illuminance information acquisition section 304b acquires the second illuminance information indicating the illuminance of the outside of the moving body and the predicted illuminance predicted by the image illuminance prediction section 314 (step S34).

The light adjusting control section 305b controls a light adjustment by the light adjusting device 42 included in the moving body on the basis of the first illuminance information and the second illuminance information (step S35). That is, the light adjusting control section 305b determines the light shielding degree indicating the degree of light shielding by the light adjusting device 42.

The signal output section 306b outputs a signal indicating the light shielding degree determined by the light adjusting control section 305b to each of the light adjusting units 40 (step S36). Then, the light adjusting driver 41 causes the light adjusting device 42 to shield light on the basis of the signal output from the signal output section 306b.

The signal processing device 30b determines whether the moving body has arrived at the destination (step S37). In a case where the moving object has not arrived at the destination (step S37; No), the signal processing device 30b proceeds to step S32 and continues the process.

In a case where the moving object has arrived at the destination (step S37; Yes), the signal processing device 30b ends the light adjustment processing.

As described above, the signal processing device 30b according to the third embodiment predicts the predicted illuminance with which the moving body is irradiated in the near future on the basis of the image information. Then, the signal processing device 30b determines the light shielding degree of the light adjusting device 42 on the basis of the result of a comparison between the illuminance in the vehicle of the moving body and the predicted illuminance. For example, in a case where the predicted illuminance predicted on the basis of the image information indicates that light with high illuminance is radiated, the signal processing device 30b increases the light shielding degree in a stepwise manner before light with high illuminance is radiated. As described above, since the signal processing device 30b can keep the brightness inside the moving body constant by adjusting light in advance, it is possible to improve the comfort in the vehicle. Furthermore, the signal processing device 30b can suppress sudden light shielding by adjusting light in advance.

### (5. Fourth Embodiment)

A light adjusting system 1c according to the fourth embodiment predicts future illuminance on the basis of a car navigation system and captured image information. The same components as those of the first embodiment are denoted by the same reference numerals, and the description thereof will be omitted.

The light adjusting system 1c predicts predicted illuminance of light radiated from the surroundings when the moving body travels along the movement route on the basis of the movement route determined by the car navigation system and the map information. Further, the light adjusting system 1c calculates a target illuminance indicating a target value of the illuminance of the inside of the moving body on the basis of the predicted illuminance. In addition, the light adjusting system 1c predicts predicted illuminance with which the moving body is irradiated on the basis of image information obtained by imaging the surroundings of the moving body. Then, the light adjusting system 1c controls a light adjustment by a device included in the moving body on the basis of the target illuminance and the predicted illuminance calculated on the basis of the image information.

### 1. Configuration of Light Adjusting System According to Fourth Embodiment]

FIG. 16 is a block diagram depicting an example of a schematic hardware configuration of the light adjusting system 1c according to a fourth embodiment of the present disclosure. As in the light adjusting system 1c according to the second embodiment, the light adjusting system 1c includes the positional information receiving section 50, the communication section 60, and the ECU 70.

In addition, as in the light adjusting system 1c according to the third embodiment, the front unit 11, the right unit 12, the left unit 13, the rear unit 14, and the in-vehicle unit 15 of the light adjusting system 1c include visible light cameras 112, 122, 132, 142, and 152, respectively.

### 2. Configuration of Signal Processing Device According to Fourth Embodiment]

FIG. 17 is a block diagram depicting an example of a functional configuration of a signal processing device 30c according to the fourth embodiment of the present disclosure. A control section 31c of the signal processing device 30c includes the light adjustment degree setting section 301, the first illuminance information acquisition section 302, the external illuminance acquisition section 303, the navigation information acquisition section 307, the destination setting section 308, the vehicle information acquisition section 309, the route illuminance prediction section 310, the mode setting section 311, the target illuminance calculation section 312, the image information acquisition section 313, the image illuminance prediction section 314, a second illuminance information acquisition section 304c, a light adjusting control section 305c, and a signal output section 306c.

The light adjustment degree setting section 301, the first illuminance information acquisition section 302, and the external illuminance acquisition section 303 have functions similar to those of the first embodiment.

The navigation information acquisition section 307, the destination setting section 308, the route illuminance prediction section 310, the vehicle information acquisition section 309, the mode setting section 311, and the target illuminance calculation section 312 have functions similar to those of the second embodiment.

The image information acquisition section 313 and the image illuminance prediction section 314 have functions similar to those of the third embodiment.

The second illuminance information acquisition section 304c acquires the illuminance of the outside of the moving body acquired by the external illuminance acquisition section 303, the target illuminance calculated by the target illuminance calculation section 312, and the predicted illuminance predicted by the image illuminance prediction section 314. Then, the second illuminance information acquisition section 304c outputs, to the light adjusting control section 305c, second illuminance information including the illuminance of the outside of the moving body acquired by the external illuminance acquisition section 303, the target illuminance calculated by the target illuminance calculation section 312, and the predicted illuminance predicted by the image illuminance prediction section 314.

As in the second embodiment, the light adjusting control section 305c calculates a difference between the illuminance of the inside of the moving body indicated by the first illuminance information and the target illuminance indicated by the second illuminance information at each point of the movement route. Then, the light adjusting control section 305c adjusts the light shielding degree so as to achieve the target illuminance calculated at each point of the movement route. However, an error occurs in the predicted illuminance due to factors not included in the map information. Therefore, as in the third embodiment, the light adjusting control section 305c controls a light adjustment by the light adjusting device 42 included in the moving body on the basis of the result of a comparison between the illuminance of the first illuminance information and the predicted illuminance of the second illuminance information. That is, the light adjusting control section 305c corrects the light shielding degree calculated so as to achieve the target illuminance calculated at each point of the movement route according to the light shielding degree calculated on the basis of the image information.

More specifically, the light adjusting control section 305c calculates a difference between the illuminance of the inside of the moving body indicated by the first illuminance information and the target illuminance indicated by the second illuminance information at each point. Furthermore, the light adjusting control section 305c calculates the light shielding degree of the light adjusting device 42 at each point on the basis of the calculated difference. In addition, the light adjusting control section 305c compares the current illuminance of the inside of the moving body with the predicted illuminance when the time to reach the object to be detected of the image illuminance prediction section 314 has elapsed, and calculates the light shielding degree to be changed in a stepwise manner. That is, the light adjusting control section 305c calculates the light shielding degree of the light adjusting device 42 at each point until the reached time from the present elapses. Then, the light adjusting control section 305c corrects the light shielding degree of the light adjusting device 42 calculated on the basis of the target illuminance at each point with the light shielding degree of the light adjusting device 42 calculated on the basis of the image information at each point.

Furthermore, as in the first embodiment, the light adjusting control section 305c may control a light adjustment by the light adjusting device 42 on the basis of a difference between the internal illuminance included in the first acquisition information and the external illuminance included in the second acquisition information. Furthermore, as in the first embodiment, the light adjusting control section 305c may control a light adjustment by the light adjusting device 42 on the basis of the difference in illuminance and the level of the light adjustment degree set by the light adjustment degree setting section 301. As a result, the light adjustment degree setting section 301 can control a light adjustment so as to be suitable for actual illuminance. Furthermore, the light adjusting control section 305c controls a light adjustment before arrival at the current point so as to achieve illuminance suitable for the current point. Therefore, the light adjusting control section 305c can suppress a rapid change in light adjustment.

The signal output section 306c outputs a signal indicating the light shielding degree determined by the light adjusting control section 305c to each of the light adjusting units 40.

### 3. Light Adjustment Processing Procedure According to Fourth Embodiment]

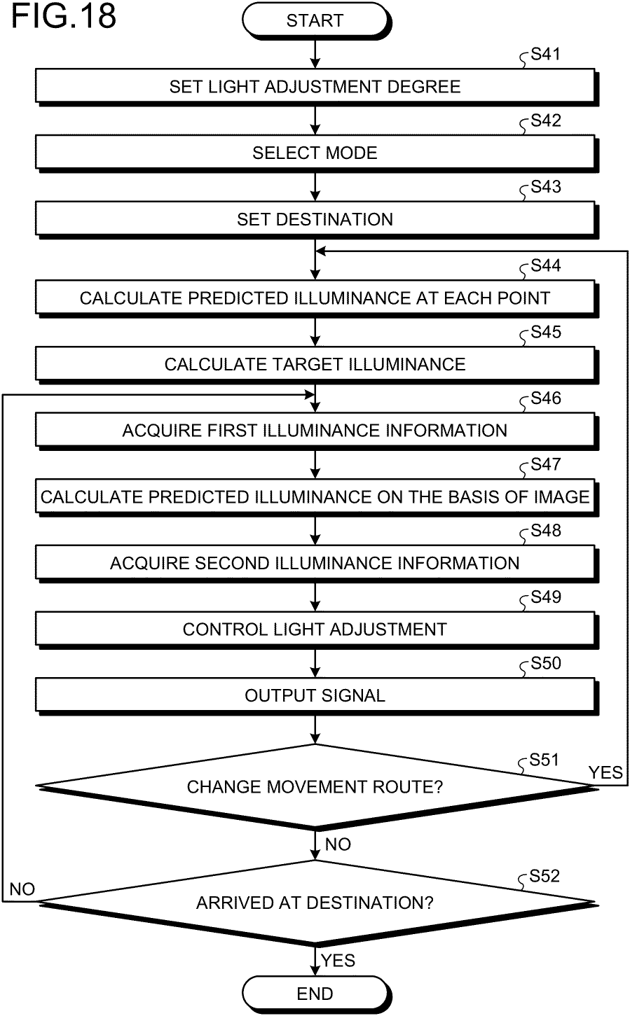

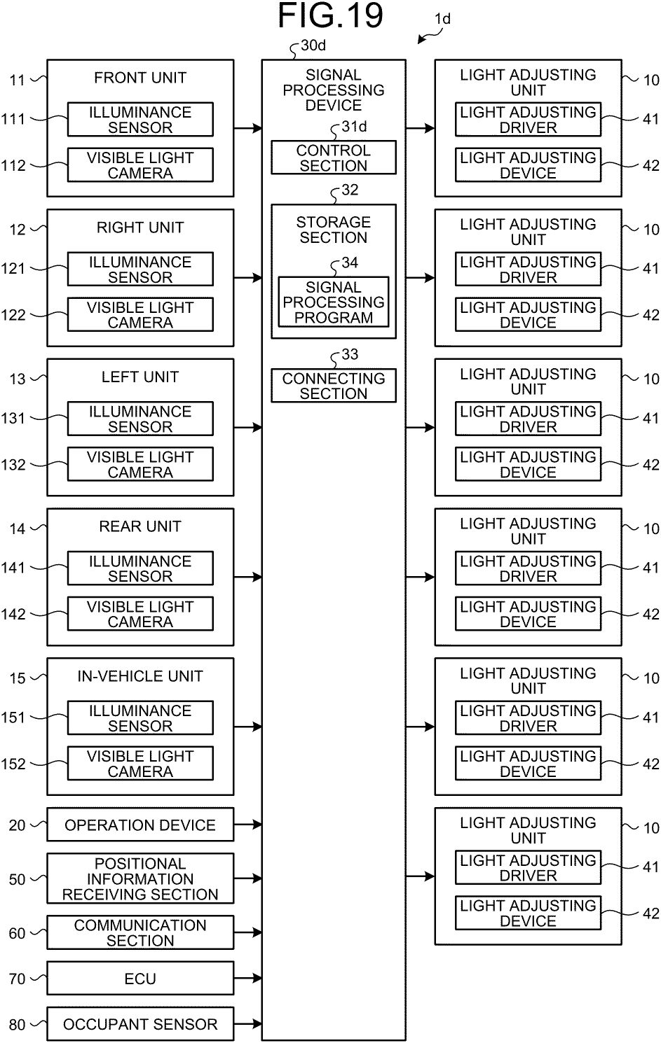

FIG. 18 is a flowchart depicting an example of the light adjustment processing executed by the light adjusting system 1c according to the fourth embodiment of the present disclosure.

The light adjustment degree setting section 301 sets a light adjustment degree indicating a degree of a light adjustment by the light adjusting device 42 (step S41). That is, the light adjustment degree setting section 301 sets the level of light adjustment on the basis of the operation received by the operation device 20.

The mode setting section 311 sets a light adjustment mode (step S42). That is, the mode setting section 311 sets one of the environment mode, the adaptation mode, and the fixed mode.

The destination setting section 308 sets a destination of the moving body (step S43).

The route illuminance prediction section 310 calculates the predicted illuminance at each elapsed time, that is, at each point of the movement route, on the basis of the information acquired by the navigation information acquisition section 307 and the destination (step S44).

The target illuminance calculation section 312 calculates the target illuminance at each point on the movement route on the basis of the predicted illuminance and the light adjustment mode (step S45).

The first illuminance information acquisition section 302 acquires first illuminance information indicating illuminance of the inside of the moving body (step S46).

The image illuminance prediction section 314 calculates predicted illuminance indicating a prediction value of illuminance of the outside of the moving body on the basis of the image information acquired by the image information acquisition section 313 (step S47).

The second illuminance information acquisition section 304c acquires the second illuminance information indicating the illuminance of the outside of the moving body, the target illuminance calculated by the target illuminance calculation section 312, and the predicted illuminance predicted by the image illuminance prediction section 314 (step S48).

The light adjusting control section 305c controls a light adjustment by the light adjusting device 42 included in the moving body on the basis of the first illuminance information indicating the illuminance of the inside of the moving body, and the second illuminance information indicating the illuminance of the outside of the moving body, the target illuminance calculated by the target illuminance calculation section 312, and the predicted illuminance predicted by the image illuminance prediction section 314 (step S49). That is, the light adjusting control section 305c determines the light shielding degree indicating the degree of light shielding by the light adjusting device 42.

The signal output section 306c outputs a signal indicating the light shielding degree determined by the light adjusting control section 305c to the light adjusting unit 40 (step S50). Then, the light adjusting driver 41 causes the light adjusting device 42 to shield light on the basis of the signal output from the signal output section 306c.

The navigation information acquisition section 307 determines whether the movement route has been changed (step S51). That is, the navigation information acquisition section 307 determines whether positional information indicating a position deviated from the set movement route has been acquired. In a case where the movement route is changed (step S51; Yes), the light adjusting system 1c proceeds to step S44.

In a case where the movement route has not been changed (step S51; No), the navigation information acquisition section 307 determines whether the moving object has arrived at the destination (step S52). That is, the navigation information acquisition section 307 determines whether positional information indicating a destination has been acquired. In a case where the moving object has not arrived at the destination (step S52; No), the first illuminance information acquisition section 302 acquires the first illuminance information in step S46.

In a case where the moving object has arrived at the destination (step S52; Yes), the light adjusting system 1c ends the light adjustment processing.

As described above, as in the signal processing device 30a according to the second embodiment, the signal processing device 30c according to the fourth embodiment calculates the target illuminance on the basis of the information of the car navigation system. Furthermore, the signal processing device 30c calculates the predicted illuminance on the basis of the image information, as in the signal processing device 30b according to the third embodiment. Then, the signal processing device 30c determines the light shielding degree using the target illuminance and the predicted illuminance calculated on the basis of the image information. As described above, the signal processing device 30c can predict the illuminance more accurately by using the information about both the target illuminance and the predicted illuminance calculated on the basis of the image information. Since the signal processing device 30c can suppress sudden light shielding, it is possible to improve the comfort in the vehicle.

### (6. First Modification of Fourth Embodiment)

A light adjusting system 1d according to the first modification of the fourth embodiment controls the light adjusting device 42 of the moving body according to the position and the posture of the occupant. The same reference numerals are given to the same configurations as those of the fourth embodiment, and the description thereof will be omitted.

The light adjusting system 1d changes the position of the light adjustment by the light adjusting device 42 according to the position and the posture of the occupant. For example, in a case where there is no occupant in the rear seat, the light adjusting system 1d reduces the degree of a light adjustment by the light adjusting device 42 included in the side glass of the rear seat. As a result, the light adjusting system 1d reduces the power consumption used for the light adjustment.

Furthermore, the light adjusting system 1d controls a portion of the light adjusting device 42 to be shielded from light according to the posture of the occupant. The position of the face changes between a case where the occupant sits shallowly on the seat and a case where the occupant sits deeply on the seat. In addition, when the position of the face changes, a portion of the window of the moving body to be shielded from light changes. Therefore, the light adjusting system 1d controls a portion of the light adjusting device 42 to be shielded from light according to the posture of the occupant.

### 1. Configuration of Light Adjusting System According to First Modification of Fourth Embodiment]

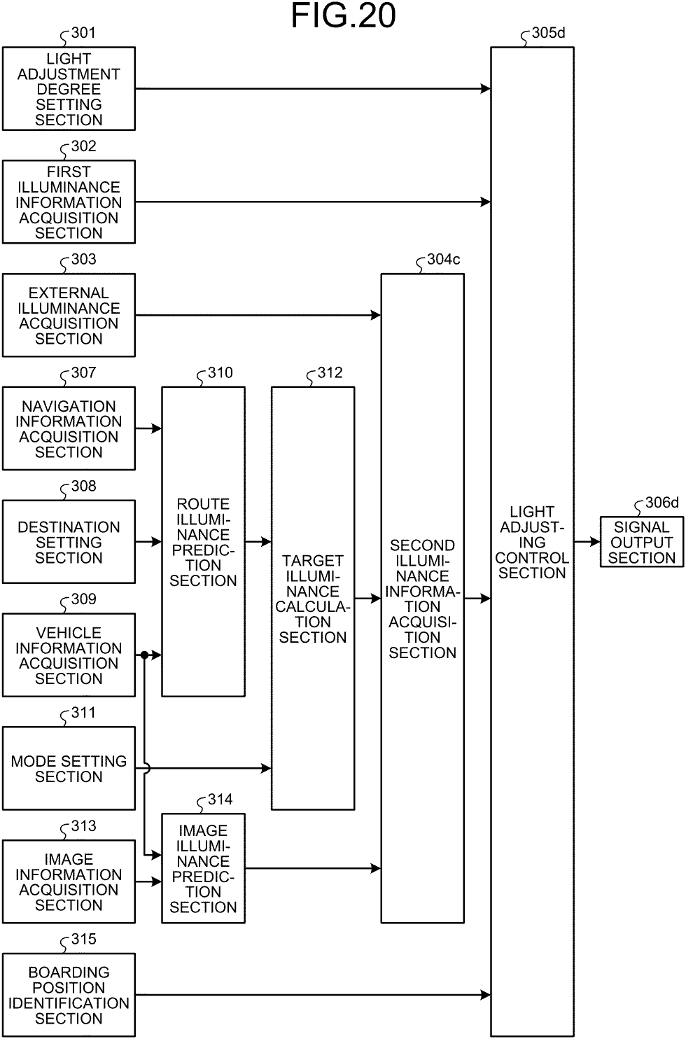

FIG. 19 is a block diagram depicting an example of a schematic hardware configuration of the light adjusting system 1d according to the first modification of the fourth embodiment of the present disclosure. The light adjusting system 1d is different from the light adjusting system 1d according to the fourth embodiment in that it includes an occupant sensor 80.

The occupant sensor 80 is a sensor that detects the position and the posture of the occupant. The occupant sensor 80 is a time of flight (ToF) sensor that measures the distance to the object. The occupant sensor 80 detects the position and the posture of the occupant by generating a distance image indicating the distance to the object. Incidentally, the occupant sensor 80 is not limited to the ToF sensor, but may be a camera that captures an image for identifying the position of the face of the occupant, an infrared sensor that detects the position and the posture of the occupant, or another sensor.

### 2. Configuration of Signal Processing Device According to First Modification of Fourth Embodiment]

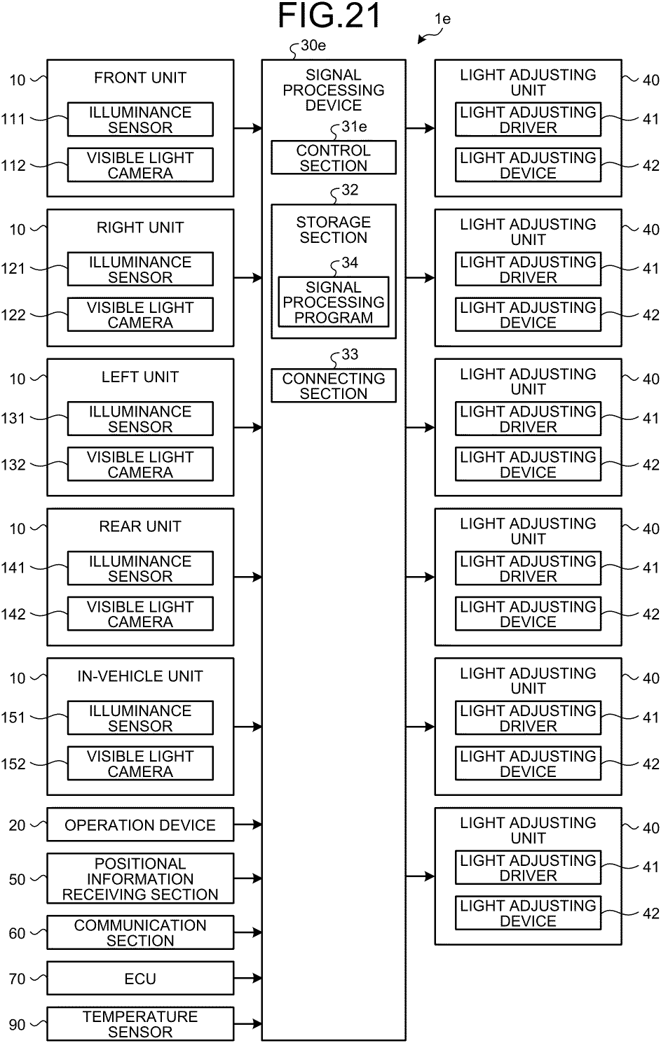

FIG. 20 is a block diagram depicting an example of a functional configuration of a signal processing device 30d according to the first modification of the fourth embodiment of the present disclosure. A control section 31d of signal processing device 30d includes the light adjustment degree setting section 301, the first illuminance information acquisition section 302, the external illuminance acquisition section 303, the navigation information acquisition section 307, the destination setting section 308, the route illuminance prediction section 310, the vehicle information acquisition section 309, the mode setting section 311, the target illuminance calculation section 312, the image information acquisition section 313, the image illuminance prediction section 314, the second illuminance information acquisition section 304c, a boarding position identification section 315, a light adjusting control section 305d, and a signal output section 306d.

The light adjustment degree setting section 301, the first illuminance information acquisition section 302, the external illuminance acquisition section 303, the navigation information acquisition section 307, the destination setting section 308, the route illuminance prediction section 310, the vehicle information acquisition section 309, the mode setting section 311, the target illuminance calculation section 312, the image information acquisition section 313, the image illuminance prediction section 314, and the second illuminance information acquisition section 304c have functions similar to those of the light adjusting system 1d according to the fourth embodiment.

The boarding position identification section 315 identifies the position and the posture of the occupant on board the moving body. More specifically, the boarding position identification section 315 identifies the position and the posture of the occupant on board the moving body on the basis of the information output from the occupant sensor 80. For example, the boarding position identification section 315 identifies the position of the face of the occupant from the information output from the occupant sensor 80. Accordingly, the boarding position identification section 315 identifies at which position of the moving body the occupant is present. Further, the boarding position identification section 315 identifies the posture in which the occupant sits shallowly, sits deeply or the like. Incidentally, the boarding position identification section 315 may identify the position and the posture not only by the position of the occupant’s face but also by another method.

The light adjusting control section 305d controls a light adjustment by the light adjusting device 42 according to the position of the occupant identified by the boarding position identification section 315. Here, the signal processing device 30d has light adjustment target information in which a boarding position of an occupant in a moving body such as a seat of the moving body is associated with the light adjusting device 42. The light adjusting control section 305d identifies the light adjusting device 42 associated with the boarding position where the occupant identified by the boarding position identification section 315 is located on the basis of the light adjustment target information. Then, the light adjusting control section 305d controls a light adjustment by the identified light adjusting device 42 on the basis of a result of a comparison between the first illuminance information and the second illuminance information. That is, the light adjusting control section 305d determines the light shielding degree of the identified light adjusting device 42. On the other hand, the light adjusting control section 305d reduces the light shielding degree with respect to the light adjusting device 42 that is not associated with the boarding position where the occupant identified by the boarding position identification section 315 is located. As a result, the light adjusting control section 305d can reduce power consumption used for the light adjustment.

In addition, the light adjusting control section 305d controls a light adjustment by the device according to the position and the posture of the occupant identified by the boarding position identification section 315. Here, the signal processing device 30d has light adjustment portion information in which the posture of the occupant is associated with the light shielding portion indicating the portion light shielded by the light adjusting device 42. For example, in the light adjustment portion information, the position of the face of the occupant as the posture of the occupant and the light shielding portion are associated with each other. The light adjusting control section 305d identifies a light shielding portion of the light adjusting device 42 associated with the posture of the occupant such as the position of the face of the occupant identified by the boarding position identification section 315 on the basis of the light adjustment portion information. Then, the light adjusting control section 305d controls a light adjustment for the light shielding portion of the light adjusting device 42 on the basis of a result of a comparison between the first illuminance information and the second illuminance information. That is, the light adjusting control section 305d determines the light shielding degree of the light shielding portion of the light adjusting device 42.

As described above, the signal processing device 30d according to the first modification of the fourth embodiment identifies the position and the posture of the occupant on board the moving body. Then, the signal processing device 30d executes a light adjustment according to the position and the posture of the occupant. In other words, the signal processing device 30d suppresses a light adjustment according to the position and the posture of the occupant. Therefore, the signal processing device 30d can reduce power consumption used for the light adjustment.

### (7. Second Modification of Fourth Embodiment)

A light adjusting system 1e according to the second modification of the fourth embodiment controls the light adjusting device 42 of the moving body according to the temperature of the inside of the moving body. The same reference numerals are given to the same configurations as those of the fourth embodiment, and the description thereof will be omitted.

In a case where the temperature of the inside of the moving body is high, the light adjusting system 1e raises the light shielding degree of the light adjusting device 42. On the other hand, in a case where the temperature of the inside of the moving body is low, the light adjusting system 1e lowers the light shielding degree of the light adjusting device 42. Thus, the light adjusting system 1e controls the temperature of the inside of the moving body.

### 1. Configuration of Light Adjusting System According to Second Modification of Fourth Embodiment]

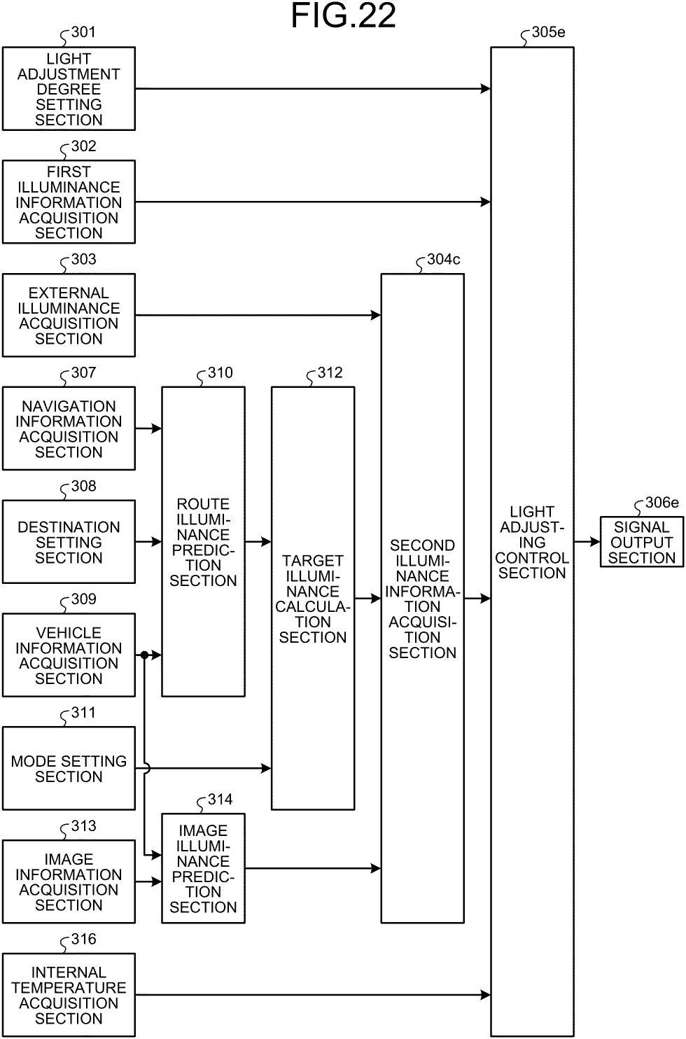

FIG. 21 is a block diagram depicting an example of a schematic hardware configuration of the light adjusting system 1e according to the first modification of the fourth embodiment of the present disclosure. The light adjusting system 1e is different from the light adjusting system 1e according to the fourth embodiment in that it includes a temperature sensor 90. The temperature sensor 90 is a sensor that measures the temperature of the inside of the moving body.

### 2. Configuration of Signal Processing Device According to Second Modification of Fourth Embodiment]

FIG. 22 is a block diagram depicting an example of a functional configuration of a signal processing device 30e according to the second modification of the fourth embodiment of the present disclosure. A control section 31e of the signal processing device 30e includes the light adjustment degree setting section 301, the first illuminance information acquisition section 302, the external illuminance acquisition section 303, the navigation information acquisition section 307, the destination setting section 308, the route illuminance prediction section 310, the vehicle information acquisition section 309, the mode setting section 311, the target illuminance calculation section 312, the image information acquisition section 313, the image illuminance prediction section 314, the second illuminance information acquisition section 304c, an internal temperature acquisition section 316, a light adjusting control section 305e, and a signal output section 306e.

The light adjustment degree setting section 301, the first illuminance information acquisition section 302, the external illuminance acquisition section 303, the navigation information acquisition section 307, the destination setting section 308, the route illuminance prediction section 310, the vehicle information acquisition section 309, the mode setting section 311, the target illuminance calculation section 312, the image information acquisition section 313, the image illuminance prediction section 314, and the second illuminance information acquisition section 304c have functions similar to those of the light adjusting system 1e according to the fourth embodiment.

The internal temperature acquisition section 316 acquires the temperature of the inside of the moving body. More specifically, the internal temperature acquisition section 316 controls the temperature sensor 90 to acquire the temperature of the inside of the moving body. Then, the internal temperature acquisition section 316 outputs the temperature of the inside of the moving body to the light adjusting control section 305e.

The light adjusting control section 305e controls a light adjustment by the light adjusting device 42 according to the temperature acquired by the internal temperature acquisition section 316. Here, the light adjusting control section 305e has reference temperature information indicating a reference temperature of the inside of the moving body. The reference temperature information may be a set temperature of the air conditioner or a preset temperature for light adjustment.

The light adjusting control section 305e controls a light adjustment by the light adjusting device 42 on the basis of the temperature acquired by the internal temperature acquisition section 316 and the temperature indicated by the reference temperature information. For example, the light adjusting control section 305e increases the light shielding degree in a case where the temperature acquired by the internal temperature acquisition section 316 is higher than the temperature indicated by the reference temperature information. As a result, the amount of light entering the inside of the moving body is reduced, so that the light adjusting control section 305e can lower the temperature of the inside of the moving body. On the other hand, the light adjusting control section 305e increases the light shielding degree in a case where the temperature acquired by the internal temperature acquisition section 316 is lower than the temperature indicated by the reference temperature information. As a result, since the amount of light entering the inside of the moving body increases, the light adjusting control section 305e can raise the temperature of the inside of the moving body.

As described above, the signal processing device 30e according to the second modification of the fourth embodiment adjusts light according to the temperature of the moving body. That is, the signal processing device 30e changes the amount of light entering the moving body according to the temperature of the moving body. Therefore, since the signal processing device 30e can set the moving body at a more appropriate temperature, the comfort in the vehicle can be improved.

Incidentally, in the first embodiment, the second embodiment, the third embodiment, the fourth embodiment, the first modification of the fourth embodiment, and the second modification of the fourth embodiment, the light adjusting device 42 is described as a device such as a liquid crystal panel that shields light incident from a window of a moving body. However, the light adjusting device 42 may be a light emitting device such as an indoor light. For example, when a moving body enters a tunnel or the like, the inside of the vehicle is dark. In order to prevent such a change in illuminance in the vehicle, the light adjusting device 42 increases the intensity of light emission. Furthermore, in order to prevent the illuminance in the vehicle from changing due to light radiation from the outside, the light adjusting device 42 weakens the intensity of light emission.

### (8. Application Example)

The technology according to the present disclosure can be applied to various products. For example, the technology according to the present disclosure may be realized as a device mounted on any type of moving body such as an automobile, an electric vehicle, or a hybrid electric vehicle.

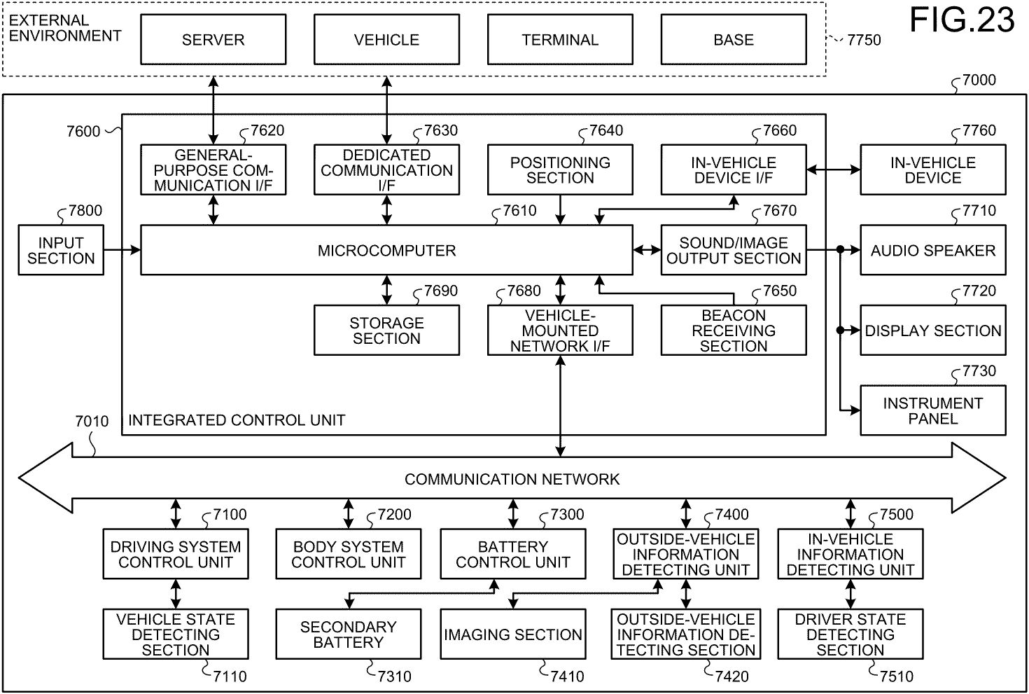

FIG. 23 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 23, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 23 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

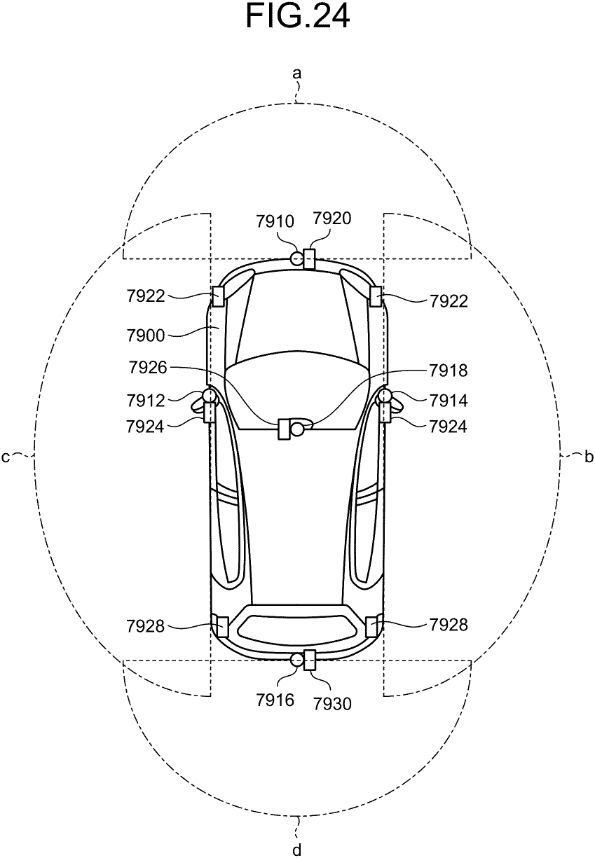

FIG. 24 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 24 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird’s-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 23, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird’s-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by Universal Serial Bus (USB), high-definition multimedia interface (HDMI (registered trademark)), mobile high-definition link (MHL), or the like via a connection terminal (and a cable when necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 23, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 23 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Incidentally, a computer program for implementing the function of each of the signal processing devices 30, 30a, 30b, 30c, 30d, and 30e according to the present embodiment described with reference to FIGS. 2, 7, 14, 17, 20, and 22, respectively, can be mounted on any control unit or the like. Furthermore, it is also possible to provide a computer-readable recording medium storing such a computer program. The recording medium is, for example, a magnetic disk, an optical disk, a magneto-optical disk, a flash memory, or the like. Furthermore, the computer program described above may be distributed via, for example, a network without using a recording medium.

In the vehicle control system 7000 described above, each of the signal processing devices 30, 30a, 30b, 30c, 30d, and 30e according to the present embodiment described with reference to FIGS. 2, 7, 14, 17, 20, and 22, respectively, can be applied to the integrated control unit 7600 of the application example depicted in FIG. 23. For example, the light adjustment degree setting section 301, the first illuminance information acquisition section 302, the external illuminance acquisition section 303, the navigation information acquisition section 307, the destination setting section 308, the vehicle information acquisition section 309, the route illuminance prediction section 310, the mode setting section 311, the target illuminance calculation section 312, the image information acquisition section 313, the image illuminance prediction section 314, the second illuminance information acquisition sections 304, 304a, 304b, and 304c, the light adjusting control sections 305, 305a, 305b, 305c, 305d, and 305e, and the signal output sections 306, 306a, 306b, 306c, 306d, and 306e of the signal processing devices 30, 30a, 30b, 30c, 30d, and 30e correspond to the microcomputer 7610, the storage section 7690, and the vehicle-mounted network I/F 7680 of the integrated control unit 7600.

In addition, at least some components of the signal processing devices 30, 30a, 30b, 30c, 30d, and 30e described with reference to FIGS. 2, 7, 14, 17, 20, and 22, respectively, may be realized in a module (for example, an integrated circuit module composed of one die) for the integrated control unit 7600 depicted in FIG. 23. Alternatively, the signal processing devices 30, 30a, 30b, 30c, 30d, and 30e described with reference to FIGS. 2, 7, 14, 17, 20, and 22, respectively, may be realized by a plurality of control units of the vehicle control system 7000 depicted in FIG. 23.

### (Effects)

The signal processing device 30, 30a, 30b, 30c, 30d, 30e includes the first illuminance information acquisition section 302, the second illuminance information acquisition section 304, 304a, 304b, 304c, and the light adjusting control section 305, 305a, 305b, 305c, 305d, 305e. The first illuminance information acquisition section 302 acquires first illuminance information indicating illuminance of the inside of the moving body. The second illuminance information acquisition section 304, 304a, 304b, 304c acquires the second illuminance information indicating illuminance to be compared with the first illuminance information. The light adjusting control section 305, 305a, 305b, 305c, 305d, 305e controls a light adjustment by the light adjusting device 42 included in the moving body on the basis of a result of a comparison between the illuminance of the first illuminance information and the illuminance of the second illuminance information.

As a result, the signal processing device 30, 30a, 30b, 30c, 30d, 30e can control the light shielding degree of the light adjusting device 42 on the basis of the result of a comparison between the illuminance in the vehicle of the moving body and the illuminance to be compared. Therefore, the signal processing device 30, 30a, 30b, 30c, 30d, 30e can improve the comfort in the vehicle.

The second illuminance information acquisition section 304, 304a, 304b, 304c acquire second illuminance information indicating the illuminance measured by the illuminance sensors 111, 121, 131, and 141 that measure the illuminance of the outside of the moving body. The light adjusting control section 305, 305a, 305b, 305c, 305d, 305e controls a light adjustment by the light adjusting device 42 included in the moving body on the basis of a result of a comparison between the illuminance of the first illuminance information and the illuminance of the second illuminance information.

As a result, the signal processing device 30, 30a, 30b, 30c, 30d, 30e can adjust light on the basis of the result of a comparison between the illuminance of the inside of the moving body and the illuminance of the outside of the moving body.

The light adjusting control section 305, 305a, 305b, 305c, 305d, 305e controls a light adjustment by the light adjusting device 42 for each of the plurality of light adjusting devices 42 included in the moving body.

As a result, the signal processing device 30, 30a, 30b, 30c, 30d, 30e can execute a light adjustment suitable for the light adjusting device 42 included in the moving body.

The second illuminance information acquisition section 304, 304a, 304b, 304c acquires the second illuminance information indicating the illuminance measured by the illuminance sensors 111, 121, 131, and 141 associated with the plurality of respective light adjusting devices 42 included in the moving body. The light adjusting control section 305, 305a, 305b, 305c, 305d, 305e controls a light adjustment by the light adjusting devices 42 associated with the respective illuminance sensors 111, 121, 131, and 141 that have measured the illuminance of the second illuminance information on the basis of the result of a comparison between the illuminance of the first illuminance information and the illuminance of the second illuminance information.

As a result, the signal processing device 30, 30a, 30b, 30c can cause the light adjusting device 42 to adjust light according to the direction of light radiated to the moving body.

The light adjusting control section 305, 305a, 305b, 305c, 305d, 305e controls a light adjustment by the light adjusting device 42 that shields light incident from a window of the moving body.

As a result, the signal processing device 30, 30a, 30b, 30c, 30d, 30e can shield light incident from the window of the moving body.

Each of the signal processing device 30, 30a, 30b, 30c, 30d, 30e further includes the light adjustment degree setting section 301 that sets a light adjustment degree indicating a degree of a light adjustment by the light adjusting device 42. The light adjusting control section 305, 305a, 305b, 305c, 305d, 305e controls a light adjustment by the light adjusting device 42 on the basis of the light adjustment degree set by the light adjustment degree setting section 301.

As a result, the signal processing device 30, 30a, 30b, 30c, 30d, 30e can designate the degree of light shielding by the light adjusting device 42.

The signal processing device 30a, 30b, 30c, 30d, 30e further includes the route illuminance prediction section 310 or the image illuminance prediction section 314 that predicts predicted illuminance indicating a prediction value of illuminance of the outside of the moving body. The second illuminance information acquisition section 304, 304a, 304b, 304c acquires the second illuminance information indicating predicted illuminance. The light adjusting control section 305, 305a, 305b, 305c, 305d, 305e controls a light adjustment by the light adjusting device 42 on the basis of a result of a comparison between the illuminance of the first illuminance information and the predicted illuminance of the second illuminance information.

As a result, the signal processing device 30a, 30b, 30c, 30d, 30e can adjust light before the moving body is irradiated with light on the basis of light radiated to the moving body in the future. Therefore, the signal processing device 30a, 30b, 30c, 30d, 30e can suppress sudden light adjustment.

The image illuminance prediction section 314 predicts predicted illuminance on the basis of image information about surroundings of the moving body.

Accordingly, since the signal processing device 30b, 30c, 30d, 30e predicts the illuminance on the basis of the image information, the accuracy of the predicted illuminance can be improved.

The signal processing device 30a, 30c, 30d, 30e further includes the target illuminance calculation section 312 that calculates a target illuminance indicating a target value of illuminance of the inside of the moving body on the basis of the predicted illuminance. The second illuminance information acquisition section 304, 304a, 304b, 304c acquires the second illuminance information indicating the target illuminance. The light adjusting control section 305, 305a, 305b, 305c, 305d, 305e controls a light adjustment by the light adjusting device 42 on the basis of a result of a comparison between the illuminance of the first illuminance information and target illuminance of the second illuminance information.

As a result, since the signal processing device 30a, 30b, 30c, 30d, 30e adjusts light in accordance with the target illuminance calculated on the basis of the predicted illuminance, it is possible to execute a light adjustment according to the illuminance with which the moving body is irradiated in the future. Therefore, the signal processing device 30a, 30b, 30c, 30d, 30e can suppress sudden light adjustment.

The signal processing device 30a, 30c, 30d, 30e further includes the mode setting section 311 that sets a light adjustment mode. The target illuminance calculation section 312 calculates the target illuminance on the basis of the mode and the predicted illuminance.

As a result, the signal processing device 30a, 30c, 30d, 30e can select the light adjusting method without restriction.

The route illuminance prediction section 310 predicts predicted illuminance on the basis of map information indicating illuminance of surroundings of the movement route of the moving body to the destination.

As a result, the signal processing device 30a, 30c, 30d, 30e can predict, at each point, illuminance of light radiated until the moving body arrives at the destination. Therefore, the signal processing device 30a, 30b, 30c, 30d, 30e can suppress sudden light adjustment.

The mode setting section 311 sets a mode to an environment mode in which light is adjusted so as to have illuminance, according to the surrounding environment, indicated by the predicted illuminance. When the mode is set to the environment mode, the target illuminance calculation section 312 calculates the target illuminance on the basis of the predicted illuminance at each point of the movement route.

As a result, the signal processing device 30a, 30c, 30d, 30e can execute a light adjustment according to the surrounding illuminance.

The mode setting section 311 sets a mode to an adaptation mode for adapting to the predicted illuminance at the destination in a stepwise manner. When the mode is set to the adaptation mode, the target illuminance calculation section 312 calculates target illuminance that linearly changes from the predicted illuminance at a current location of the moving body to the predicted illuminance at the destination.

As a result, the signal processing device 30a, 30c, 30d, 30e can execute a light adjustment to be adapted to the illuminance at the destination in a stepwise manner.

The light adjusting control section 305, 305a, 305b, 305c, 305d, 305e controls a light adjustment by the light adjusting device 42 for each portion of the light adjusting device 42.

As a result, the signal processing device 30, 30a, 30b, 30c, 30d, 30e can execute a light adjustment suitable for a portion, of the window of the moving body, on which light is incident.

The signal processing device 30d further includes the boarding position identification section 315 that identifies the position of the occupant on board the moving body. The light adjusting control section 305, 305a, 305b, 305c, 305d, 305e controls a light adjustment by the light adjusting device 42 according to the position of the occupant identified by the boarding position identification section 315.

As a result, the signal processing device 30d can cause the light adjusting device 42 associated with the position where the occupant is present to perform light adjustment. In other words, the signal processing device 30d can cause the light adjusting device 42 associated with the position where the occupant is not present to suppress a light adjustment. Therefore, the signal processing device 30d can reduce power consumption for light adjustment.

The boarding position identification section 315 identifies the position and the posture of the occupant on board the moving body. The light adjusting control section 305, 305a, 305b, 305c, 305d, 305e controls a light adjustment by the light adjusting device 42 according to the position and the posture of the occupant identified by the boarding position identification section 315.

As a result, the signal processing device 30d can cause the light adjusting device 42 to execute a light adjustment suitable for the posture of the occupant. Therefore, the signal processing device 30d can improve the occupant’s comfort.

The signal processing device 30e further includes the internal temperature acquisition section 316 that acquires the temperature of the inside of the moving body. The light adjusting control section 305, 305a, 305b, 305c, 305d, 305e controls a light adjustment by the light adjusting device 42 according to the temperature acquired by the internal temperature acquisition section 316.

As a result, the signal processing device 30e can execute a light adjustment suitable for the temperature in the room of the moving body.

Further, the effects described in the present identification are merely examples and are not limited, and other effects may be present.

The present technology may also be configured as below.
(1) A signal processing device comprising:
   a first acquisition section that acquires first illuminance information indicating illuminance of an inside of a moving body;
   a second acquisition section that acquires second illuminance information indicating illuminance to be compared with the first illuminance information; and
   a light adjusting control section that controls a light adjustment by a device included in the moving body on a basis of a result of a comparison between illuminance of the first illuminance information and illuminance of the second illuminance information.
(2) The signal processing device according to (1), wherein
   the second acquisition section acquires the second illuminance information indicating illuminance measured by an illuminance sensor that measures illuminance of an outside of the moving body, and wherein
   the light adjusting control section controls a light adjustment by the device included in the moving body on a basis of a result of a comparison between illuminance of the first illuminance information and illuminance of the second illuminance information.
(3) The signal processing device according to (2), wherein
   the light adjusting control section controls a light adjustment by the device for each of a plurality of the devices included in the moving body.
(4) The signal processing device according to (3), wherein
   the second acquisition section acquires the second illuminance information indicating illuminance measured by the illuminance sensor associated with each of the plurality of devices included in the moving body, and wherein
   the light adjusting control section controls a light adjustment by the device associated with the illuminance sensor that measures illuminance of the second illuminance information on a basis of a result of a comparison between illuminance of the first illuminance information and illuminance of the second illuminance information.
(5) The signal processing device according to any one of (1) to (4), wherein
   the light adjusting control section controls a light adjustment by the device that shields light incident from a window included in the moving body.
(6) The signal processing device according to any one of (1) to (5), further comprising:
   a light adjustment degree setting section that sets a light adjustment degree indicating a degree of a light adjustment by the device, wherein
   the light adjusting control section controls a light adjustment by the device on a basis of the light adjustment degree set by the light adjustment degree setting section.
(7) The signal processing device according to any one of (1) to (6), further comprising:
   a prediction section that predicts predicted illuminance indicating a prediction value of illuminance of an outside of the moving body, wherein
   the second acquisition section acquires the second illuminance information indicating the predicted illuminance, and wherein
   the light adjusting control section controls a light adjustment by the device on a basis of a result of a comparison between illuminance of the first illuminance information and the predicted illuminance of the second illuminance information.
(8) The signal processing device according to (7), wherein
   the prediction section predicts the predicted illuminance on a basis of image information about surroundings of the moving body.
(9) The signal processing device according to (8), further comprising:
   a calculation section that calculates target illuminance indicating a target value of illuminance of the inside of the moving body on a basis of the predicted illuminance, wherein
   the second acquisition section acquires the second illuminance information indicating the target illuminance, and wherein
   the light adjusting control section controls a light adjustment by the device on a basis of a result of a comparison between illuminance of the first illuminance information and the target illuminance of the second illuminance information.
(10) The signal processing device according to (9), further comprising:
   a setting section that sets a light adjustment mode, wherein
   the calculation section calculates the target illuminance on a basis of the mode and the predicted illuminance.
(11) The signal processing device according to (10), wherein
   the prediction section predicts the predicted illuminance on a basis of map information indicating illuminance of surroundings of a movement route to a destination of the moving body.
(12) The signal processing device according to (11), wherein
   the setting section sets a mode to an environment mode in which light is adjusted so as to have illuminance, according to a surrounding environment, indicated by the predicted illuminance, and wherein
   the calculation section calculates the target illuminance on a basis of the predicted illuminance at each point of the movement route when the mode is set to the environment mode.
(13) The signal processing device according to (11), wherein
   the setting section sets a mode to an adaptation mode in which illuminance is adapted to the predicted illuminance at the destination in a stepwise manner, and wherein
   the calculation section calculates the target illuminance that linearly changes from the predicted illuminance at a current location of the moving body to the predicted illuminance at the destination when the mode is set to the adaptation mode.
(14) The signal processing device according to any one of (1) to (13), wherein
   the light adjusting control section controls a light adjustment by the device for each portion of the device.
(15) The signal processing device according to any one of (1) to (14), further comprising:
   an identification section that identifies a position of an occupant on board the moving body, wherein
   the light adjusting control section controls a light adjustment by the device according to the position of the occupant identified by the identification section.
(16) The signal processing device according to (15), wherein
   the identification section identifies a position and a posture of an occupant on board the moving body, and wherein
   the light adjusting control section controls a light adjustment by the device according to the position and the posture of the occupant identified by the identification section.
(17) The signal processing device according to any one of (1) to (16), further comprising:
   a temperature acquisition section that acquires a temperature of the inside of the moving body, wherein
   the light adjusting control section controls a light adjustment by the device according to the temperature acquired by the temperature acquisition section.
(18) A light adjusting control method comprising:
   a first acquisition step of acquiring first illuminance information indicating illuminance of an inside of a moving body;
   a second acquisition step of acquiring second illuminance information indicating illuminance to be compared with the first illuminance information; and
   a light adjusting control step of controlling a light adjustment by a device included in the moving body on a basis of a result of a comparison between illuminance of the first illuminance information and illuminance of the second illuminance information.
(19) A signal processing program for causing a computer to function as:
   a first acquisition section that acquires first illuminance information indicating illuminance of an inside of a moving body;
   a second acquisition section that acquires second illuminance information indicating illuminance to be compared with the first illuminance information; and
   a light adjusting control section that controls a light adjustment by a device included in the moving body on a basis of a result of a comparison between illuminance of the first illuminance information and illuminance of the second illuminance information.
(20) A light adjusting system comprising:
   an illuminance sensor that measures illuminance of light of an inside of a moving body;
   a device that adjusts brightness of light of the inside of the moving body; and
   a signal processing device that controls the light adjustment by the device on a basis of the illuminance measured by the illuminance sensor, wherein
   the signal processing device includes
   a first acquisition section that acquires first illuminance information indicating illuminance of the inside of the moving body,
   a second acquisition section that acquires second illuminance information indicating illuminance to be compared with the first illuminance information, and
   a light adjusting control section that controls a light adjustment by the device included in the moving body on a basis of a result of a comparison between illuminance of the first illuminance information and illuminance of the second illuminance information.

Reference Signs List

| 1, 1a, 1b, 1c, 1d, 1e | LIGHT ADJUSTING SYSTEM |
|---|---|
| 11 | FRONT UNIT |
| 12 | RIGHT UNIT |
| 13 | LEFT UNIT |
| 14 | REAR UNIT |
| 15 | IN-VEHICLE UNIT |
| 20 | OPERATION DEVICE |
| 30, 30a, 30b, 30c, 30d, 30e | SIGNAL PROCESSING DEVICE |
| 40 | LIGHT ADJUSTING UNIT |
| 42 | LIGHT ADJUSTING DEVICE |
| 41 | LIGHT ADJUSTING DRIVER |
| 50 | POSITIONAL INFORMATION RECEIVING SECTION |
| 60 | COMMUNICATION SECTION |
| 70 | ECU |
| 80 | OCCUPANT SENSOR |
| 90 | TEMPERATURE SENSOR |
| 111, 121, 131, 141, 151 | ILLUMINANCE SENSOR |
| 112, 122, 132, 142, 152 | VISIBLE LIGHT CAMERA |
| 301 | LIGHT ADJUSTMENT DEGREE SETTING SECTION |
| 302 | FIRST ILLUMINANCE INFORMATION ACQUISITION SECTION |
| 303 | EXTERNAL ILLUMINANCE ACQUISITION SECTION |
| 304, 304a, 304b, 304c | SECOND ILLUMINANCE INFORMATION ACQUISITION SECTION |
| 305, 305a, 305b, 305c, 305d, 305e | LIGHT ADJUSTING CONTROL SECTION |
| 306, 306a, 306b, 306c, 306d, 306e | SIGNAL OUTPUT SECTION |
| 307 | NAVIGATION INFORMATION ACQUISITION SECTION |
| 308 | DESTINATION SETTING SECTION |
| 309 | VEHICLE INFORMATION ACQUISITION SECTION |
| 310 | ROUTE ILLUMINANCE PREDICTION SECTION |
| 311 | MODE SETTING SECTION |
| 312 | TARGET ILLUMINANCE CALCULATION SECTION |
| 313 | IMAGE INFORMATION ACQUISITION SECTION |
| 314 | IMAGE ILLUMINANCE PREDICTION SECTION |
| 315 | BOARDING POSITION IDENTIFICATION SECTION |
| 316 | INTERNAL TEMPERATURE ACQUISITION SECTION |

1. A signal processing device comprising:
a first acquisition section that acquires first illuminance information indicating illuminance of an inside of a moving body;
a second acquisition section that acquires second illuminance information indicating illuminance to be compared with the first illuminance information; and
a light adjusting control section that controls a light adjustment by a device included in the moving body on a basis of a result of a comparison between illuminance of the first illuminance information and illuminance of the second illuminance information.

2. The signal processing device according to claim 1, wherein
the second acquisition section acquires the second illuminance information indicating illuminance measured by an illuminance sensor that measures illuminance of an outside of the moving body, and wherein
the light adjusting control section controls a light adjustment by the device included in the moving body on a basis of a result of a comparison between illuminance of the first illuminance information and illuminance of the second illuminance information.

3. The signal processing device according to claim 2, wherein
the light adjusting control section controls a light adjustment by the device for each of a plurality of the devices included in the moving body.

4. The signal processing device according to claim 3, wherein
the second acquisition section acquires the second illuminance information indicating illuminance measured by the illuminance sensor associated with each of the plurality of devices included in the moving body, and wherein
the light adjusting control section controls a light adjustment by the device associated with the illuminance sensor that measures illuminance of the second illuminance information on a basis of a result of a comparison between illuminance of the first illuminance information and illuminance of the second illuminance information.

5. The signal processing device according to claim 1, wherein
the light adjusting control section controls a light adjustment by the device that shields light incident from a window included in the moving body.

6. The signal processing device according to claim 1, further comprising:
a light adjustment degree setting section that sets a light adjustment degree indicating a degree of a light adjustment by the device, wherein
the light adjusting control section controls a light adjustment by the device on a basis of the light adjustment degree set by the light adjustment degree setting section.

7. The signal processing device according to claim 1, further comprising:
a prediction section that predicts predicted illuminance indicating a prediction value of illuminance of an outside of the moving body, wherein
the second acquisition section acquires the second illuminance information indicating the predicted illuminance, and wherein
the light adjusting control section controls a light adjustment by the device on a basis of a result of a comparison between illuminance of the first illuminance information and the predicted illuminance of the second illuminance information.

8. The signal processing device according to claim 7, wherein
the prediction section predicts the predicted illuminance on a basis of image information about surroundings of the moving body.

9. The signal processing device according to claim 8, further comprising:
a calculation section that calculates target illuminance indicating a target value of illuminance of the inside of the moving body on a basis of the predicted illuminance, wherein
the second acquisition section acquires the second illuminance information indicating the target illuminance, and wherein
the light adjusting control section controls a light adjustment by the device on a basis of a result of a comparison between illuminance of the first illuminance information and the target illuminance of the second illuminance information.

10. The signal processing device according to claim 9, further comprising:
a setting section that sets a light adjustment mode, wherein
the calculation section calculates the target illuminance on a basis of the mode and the predicted illuminance.

11. The signal processing device according to claim 10, wherein
the prediction section predicts the predicted illuminance on a basis of map information indicating illuminance of surroundings of a movement route to a destination of the moving body.

12. The signal processing device according to claim 11, wherein
the setting section sets a mode to an environment mode in which light is adjusted so as to have illuminance, according to a surrounding environment, indicated by the predicted illuminance, and wherein
the calculation section calculates the target illuminance on a basis of the predicted illuminance at each point of the movement route when the mode is set to the environment mode.

13. The signal processing device according to claim 11, wherein
the setting section sets a mode to an adaptation mode in which illuminance is adapted to the predicted illuminance at the destination in a stepwise manner, and wherein
the calculation section calculates the target illuminance that linearly changes from the predicted illuminance at a current location of the moving body to the predicted illuminance at the destination when the mode is set to the adaptation mode.

14. The signal processing device according to claim 1, wherein
the light adjusting control section controls a light adjustment by the device for each portion of the device.

15. The signal processing device according to claim 1, further comprising:
an identification section that identifies a position of an occupant on board the moving body, wherein
the light adjusting control section controls a light adjustment by the device according to the position of the occupant identified by the identification section.

16. The signal processing device according to claim 15, wherein
the identification section identifies a position and a posture of an occupant on board the moving body, and wherein
the light adjusting control section controls a light adjustment by the device according to the position and the posture of the occupant identified by the identification section.

17. The signal processing device according to claim 1, further comprising:
a temperature acquisition section that acquires a temperature of the inside of the moving body, wherein
the light adjusting control section controls a light adjustment by the device according to the temperature acquired by the temperature acquisition section.

18. A light adjusting control method comprising:
a first acquisition step of acquiring first illuminance information indicating illuminance of an inside of a moving body;
a second acquisition step of acquiring second illuminance information indicating illuminance to be compared with the first illuminance information; and
a light adjusting control step of controlling a light adjustment by a device included in the moving body on a basis of a result of a comparison between illuminance of the first illuminance information and illuminance of the second illuminance information.

19. A signal processing program for causing a computer to function as:
a first acquisition section that acquires first illuminance information indicating illuminance of an inside of a moving body;
a second acquisition section that acquires second illuminance information indicating illuminance to be compared with the first illuminance information; and
a light adjusting control section that controls a light adjustment by a device included in the moving body on a basis of a result of a comparison between illuminance of the first illuminance information and illuminance of the second illuminance information.

20. A light adjusting system comprising:
an illuminance sensor that measures illuminance of light of an inside of a moving body;
a device that adjusts brightness of light of the inside of the moving body; and
a signal processing device that controls the light adjustment by the device on a basis of the illuminance measured by the illuminance sensor, wherein
the signal processing device includes
a first acquisition section that acquires first illuminance information indicating illuminance of the inside of the moving body,
a second acquisition section that acquires second illuminance information indicating illuminance to be compared with the first illuminance information, and
a light adjusting control section that controls a light adjustment by the device included in the moving body on a basis of a result of a comparison between illuminance of the first illuminance information and illuminance of the second illuminance information.
